(19) United States
(12) Patent Application Publication
(10) Pub. No.: US 2023/0002699 A1
(43) Pub. Date: Jan. 5, 2023

(54) CONTINUOUS ACOUSTIC MIXING FOR PERFORMANCE ADDITIVES AND COMPOSITIONS INCLUDING THE SAME

(71) Applicant: The Lubrizol Corporation, Wickliffe, OH (US)

(72) Inventors: Chris Huener, Duffield (GB); Dean Hodgkinson, Derby (GB); Michael R. Sutton, Matlock (GB); David Moss, Derby (GB); Mark Garner, Huddersfield (GB); Clifford P. Kowall, South Euclid, OH (US)

(73) Assignee: The Lubrizol Corporation, Wickliffe, OH (US)

(21) Appl. No.: 17/621,269

(22) PCT Filed: Jun. 24, 2020
(86) PCT No.: PCT/US20/39342

§ 371 Date: Dec. 21, 2021

Related U.S. Application Data
(60) Provisional application No. 62/865,502, filed on Jun. 24, 2019.

(51) Int. Cl. C10M 169/04; C10M 177/00; C10M 135/10; C10M 137/10; C10M 137/12; C10M 135/06; C10M 129/16; C10M 133/16; C10M 135/36; C10M 129/50; C10M 133/12; C10M 135/04; C10M 129/10; C10M 129/68; C10M 139/00; C10M 141/12; C10M 155/02; C10M 145/22; C10M 145/14; C10M 143/10; C10M 149/06; C10M 149/10; C10M 157/10; C10M 161/00; C10L 1/14; C10L 1/12; C10L 10/08; C10L 10/18; C10L 10/16; B01F 31/80; B01F 25/312

(52) U.S. Cl. CPC C10M 169/044; C10M 177/00; C10M 135/10; C10M 137/10; C10M 137/12; C10M 135/06; C10M 129/16; C10M 133/16; C10M 135/36; C10M 129/50; C10M 133/12; C10M 135/04; C10M 129/10; C10M 129/68; C10M 139/00; C10M 141/12; C10M 155/02; C10M 145/22; C10M 145/14; C10M 143/10; C10M 149/06; C10M 149/10; C10M 157/10; C10M 161/00; C10L 1/14; C10L 1/12; C10L 10/08; C10L 10/18; C10L 10/16; B01F 31/84; B01F 25/312; C10M 2203/003; C10M 2219/044; C10M 2223/045; C10M 2223/06; C10M 2219/024; C10M 2207/04; C10M 2215/28; C10M 2219/106; C10M 2207/141; C10M 2215/26; C10M 2219/022; C10M 2207/023; C10M 2207/28; C10M 2227/061; C10M 2229/02; C10M 2209/102; C10M 2209/084; C10M 2205/04; C10M 2217/024; C10M 2217/028; C10N 2040/04

(57) ABSTRACT

The instant disclosure provides a process for preparing a lubricant or fuel additive mixture where an oil of lubricating viscosity or fuel are blended with additives that are mixed via an acoustic mixer. The additives and oil of lubricating viscosity or fuel can mixed together or any component of the lubricant or fuel additive mixture can be mixed separately prior to mixing to form the final lubricant. The process provides for continuous mixing to form lubricant and/or fuel additive mixture final products.

### FIELD

The instant disclosure generally relates to continuous acoustic mixing and, in particular, to continuous acoustic mixing of additives for lubricants and fuel additive mixtures.

### BACKGROUND

Mixing of additives added to base oils and fuels is an important consideration in the preparation of lubricants and fuel additive mixtures. Improperly mixed additive components, or inadequately mixed components, can lead to compositions that are hazy and/or affect the performance of the additives in the lubricant or fuel additive mixture. Thus, there is always a need for improved mixing capabilities of additives, especially when it relates to compatibility of the additive with the base oil or fuel and the compatibility of a mixture of additives. Continuous acoustic mixing, as described herein, allows for, at least, large-scale mixing of combination of additives or mixing the additive(s) with a lubricant base oil or fuel to form lubricants and fuel additive mixtures.

### SUMMARY

The instant disclosure provides for a process of mixing a lubricant or fuel mixture. The process includes mixing in an acoustic mixer one or more of an additive selected from a dispersant, an antioxidant, a performance polymer, a detergent, an antiwear agent, a friction modifier, a demulsifier, an antifoam additive, a rust inhibitor, a metal deactivator, a seal swell agent and combinations thereof to form a final product where the final product can include an additive concentrate. The mixing may further include mixing with an oil of lubricating viscosity to form a fully-formulated lubricant. The instant disclosure further provides a process for preparing a fuel mixture including mixing in an acoustic mixer a fuel with one or more of an additive selected from a dispersant, an antioxidant, a performance polymer, a detergent, an antiwear agent, a friction modifier, a demulsifier, an antifoam additive, a metal deactivator and combinations thereof to form a final product.

### BRIEF DESCRIPTION OF THE DRAWINGS

FIG. 1 illustrates an acoustic mixer according to an embodiment;

FIG. 2 is a schematic view of an acoustic mixer according to an embodiment;

FIG. 3 illustrates a manifold according to an embodiment; and

FIG. 4 illustrates a mandrel according to an embodiment.

### DETAILED DESCRIPTION

The instant disclosure relates to a process for preparing lubricant-based compositions and fuel additives. In one embodiment, the process includes mixing one or more additives as described herein to form a final product, such as an additive concentrate. In another embodiment, the process includes mixing an oil of lubricating viscosity with one or more additives to form a lubricant composition. Lubricant compositions contemplated herein can include an engine oil lubricant, a heavy-duty diesel passenger car motor oil composition, a marine diesel composition, a two-stroke engine composition, a driveline composition including a gear oil, an automatic transmission composition and a manual transmission composition, and an industrial lubricant composition, such as a hydraulic oil, industrial gear oil, a grease. The lubricant can include an additive selected from additive selected from a dispersant, an antioxidant, a performance polymer, a detergent, an antiwear agent, a friction modifier, a demulsifier, an antifoam additive, a rust inhibitor, a metal deactivator, a seal swell agent and combinations thereof. The lubricant is prepared in an acoustic mixer to form a final lubricant-based product.

In another embodiment, the disclosure provides for a process for preparing a fuel-additive mixture by mixing in an acoustic mixer a fuel with one or more additives selected from a dispersant, an antioxidant, a performance polymer, a detergent, an antiwear agent, a friction modifier, a demulsifier, an antifoam additive, a metal deactivator and combinations thereof to form the fuel-additive mixture. Additives suitable for use in compositions (lubricant compositions and fuel-additive mixtures) prepared with an acoustic mixture are more clearly described below.

### Oil of Lubricating Viscosity

One aspect of the instant disclosure relates to a process for preparing a lubricant composition. Lubricating compositions include an oil of lubricating viscosity and one or more additives as set forth below. The oil of lubricating viscosity can include such oils as natural and synthetic oils, oil derived from hydrocracking, hydrogenation, and hydrofinishing, unrefined, refined, re-refined oils or mixtures thereof. A more detailed description of unrefined, refined and re-refined oils is provided in International Publication WO2008/147704, paragraphs [0054] to [0056] (a similar disclosure is provided in US Patent Application 2010/197536, see [0072] to [0073]). A more detailed description of natural and synthetic lubricating oils is described in paragraphs [0058] to [0059]respectively of WO2008/147704 (a similar disclosure is provided in US Patent Application 2010/197536, see [0075] to [0076]). Synthetic oils may also be produced by Fischer-Tropsch reactions and typically may be hydroisomerized Fischer-Tropsch hydrocarbons or waxes. In one embodiment oils may be prepared by a Fischer-Tropsch gas-to-liquid synthetic procedure as well as other gas-to-liquid oils.

Oils of lubricating viscosity may also be defined as specified in the American Petroleum Institute (API) Base Oil Interchangeability Guidelines (2011). The five base oil groups are as follows: Group I (sulfur content >0.03 wt %, and/or <90 wt % saturates, viscosity index 80 to less than 120); Group II (sulfur content ≤0.03 wt %, and ≥90 wt % saturates, viscosity index 80 to less than 120); Group III (sulfur content ≤0.03 wt %, and ≥90 wt % saturates, viscosity index ≥120); Group IV (all polyalphaolefins (PAOs)); and Group V (all others not included in Groups I, II, III, or IV). The oil of lubricating viscosity may also be a Group II+base oil, which is an unofficial API category that refers to a Group II base oil having a viscosity index greater than or equal to 110 and less than 120, as described in SAE publication “Design Practice: Passenger Car Automatic Transmissions,” fourth Edition, AE-29, 2012, page 12-9, as well as in U.S. Pat. No. 8,216,448, column 1 line 57. The oil of lubricating viscosity may also be a Group III+ base oil, which, again, is an unofficial API category that refers to a Group III base oil having a viscosity index of greater than 130, for example 130 to 133 or even greater than 135, such as 135-145. Gas to liquid (“GTL”) oils are sometimes considered Group III+ base oils.

The oil of lubricating viscosity may be an API Group IV oil, or mixtures thereof, i.e., a polyalphaolefin. The polyalphaolefin may be prepared by metallocene catalyzed processes or from a non-metallocene process. The oil of lubricating viscosity may also comprise an API Group I, Group II, Group III, Group IV, Group V oil or mixtures thereof. Often the oil of lubricating viscosity is an API Group I, Group II, Group II+, Group III, Group IV oil or mixtures thereof. Alternatively, the oil of lubricating viscosity is often an API Group II, Group II+, Group III or Group IV oil or mixtures thereof. Alternatively, the oil of lubricating viscosity is often an API Group II, Group II+, Group III oil or mixtures thereof.

The oil of lubricating viscosity, or base oil, will overall have a kinematic viscosity at 100° C. of 2 to 10 cSt or, in some embodiments 2.25 to 9 or 2.5 to 6 or 7 or 8 cSt, as measured by ASTM D445. Kinematic viscosities for the base oil at 100° C. of from about 3.5 to 6 or from 6 to 8 cSt are also suitable.

The amount of the oil of lubricating viscosity present is typically the balance remaining after subtracting from 100 wt % the sum of the amount of the performance additives in the composition. Illustrative amounts may include 50 to 99 percent by weight, or 60 to 98, or 70 to 95, or 80 to 94, or 85 to 93 percent.

The lubricating composition may be in the form of a concentrate and/or a fully formulated lubricant. If the lubricating composition of the invention is in the form of a concentrate (which may be combined with additional oil to form, in whole or in part, a finished lubricant), the ratio of the of components of the invention to the oil of lubricating viscosity and/or to diluent oil include the ranges of 1:99 to 99:1 by weight, or 80:20 to 10:90 by weight.

### Fuel

Fuel compositions of the instant disclosure can include a fuel which is liquid at room temperature and is useful in fueling an engine. The fuel is normally a liquid at ambient conditions e.g., room temperature (20 to 30° C.). The fuel can be a hydrocarbon fuel, a nonhydrocarbon fuel, or a mixture thereof. The hydrocarbon fuel can be a petroleum distillate to include a gasoline as defined by EN228 or ASTM specification D4814, or a diesel fuel as defined by EN590 or ASTM specification D975. In an embodiment, the fuel is a gasoline, and in other embodiments the fuel is a leaded gasoline, or a nonleaded gasoline. In another embodiment, the fuel is a diesel fuel. The hydrocarbon fuel can be a hydrocarbon prepared by a gas to liquid process to include, for example, hydrocarbons prepared by a process such as the Fischer-Tropsch process. The nonhydrocarbon fuel can be an oxygen containing composition, often referred to as an oxygenate, to include an alcohol, an ether, a ketone, an ester of a carboxylic acid, a nitroalkane, or a mixture thereof. The nonhydrocarbon fuel can include for ex-ample methanol, ethanol, methyl t-butyl ether, methyl ethyl ketone, transesterified oils and/or fats from plants and animals such as rapeseed methyl ester and soybean methyl ester, and nitromethane. Mixtures of hydrocarbon and nonhydrocarbon fuels can include for example gasoline and methanol and/or ethanol, diesel fuel and ethanol, and diesel fuel and a transesterified plant oil such as rapeseed methyl ester. In one embodiment, the liquid fuel is an emulsion of water in a hydrocarbon fuel, a nonhydrocarbon fuel, or a mixture thereof. In other embodiments, the fuel can have a sulfur content on a weight basis that is 5000 ppm or less, 1000 ppm or less, 300 ppm or less, 200 ppm or less, 30 ppm or less, or 10 ppm or less. In another embodiment, the fuel can have a sulfur content on a weight basis of 1 to 100 ppm. In one embodiment the fuel contains 0 ppm to 1000 ppm, or 0 to 500 ppm, or 0 to 100 ppm, or 0 to 50 ppm, or 0 to 25 ppm, or 0 to 10 ppm, or 0 to 5 ppm of alkali metals, alkaline earth metals, transition metals or mixtures thereof. In another embodiment, the fuel contains.

A lubricating composition or fuel-additive mixture may be prepared by mixing according to the acoustic mixing disclosed herein of one or more additives (described below) with an oil of lubricating viscosity or fuel, respectively.

### Dispersant

A composition prepared according to the process disclosed herein may comprise an ashless dispersant. The dispersant may be a succinimide dispersant, a Mannich dispersant, a polyolefin succinic acid ester, amide, or ester-amide, or mixtures thereof. In one embodiment, the dispersant may be a borated succinimide dispersant. In one embodiment, the dispersant may be present as a single dispersant. In one embodiment, the dispersant may be present as a mixture of two or three different dispersants, wherein at least one may be a succinimide dispersant.

The succinimide dispersant may be a derivative of an aliphatic polyamine, or mixtures thereof. The aliphatic polyamine may be aliphatic polyamine such as an ethylenepolyamine, a propylenepolyamine, a butylenepolyamine, or mixtures thereof. In one embodiment, the aliphatic polyamine may be ethylenepolyamine. In one embodiment, the aliphatic polyamine may be selected from the group consisting of ethylenediamine, diethylenetriamine, triethylenetetramine, tetraethylenepentamine, pentaethylenehexamine, polyamine still bottoms, and mixtures thereof.

The succinimide dispersant may be a derivative of an aromatic amine, an aromatic polyamine, or mixtures thereof. The aromatic amine may be 4-aminodiphenylamine (ADPA) (also known as N-phenylphenylenediamine), derivatives of ADPA (as described in United States Patent Publications 2011/0306528 and 2010/0298185), a nitroaniline, an aminocarbazole, an amino-indazolinone, an aminopyrimidine, 4-(4-nitrophenylazo)aniline, or combinations thereof. In one embodiment, the dispersant is derivative of an aromatic amine wherein the aromatic amine has at least three non-continuous aromatic rings.

The succinimide dispersant may be a derivative of a polyether amine or polyether polyamine. Typical polyether amine compounds contain at least one ether unit and will be chain terminated with at least one amine moiety. The polyether polyamines can be based on polymers derived from C₂-C₆ epoxides such as ethylene oxide, propylene oxide, and butylene oxide. Examples of polyether polyamines are sold under the Jeffamine® brand and are commercially available from Hunstman Corporation located in Houston, Tex.

The dispersant may be a N-substituted long chain alkenyl succinimide. Examples of N-substituted long chain alkenyl succinimide include polyisobutylene succinimide. Typically, the polyisobutylene from which polyisobutylene succinic anhydride is derived has a number average molecular weight of 350 to 5000, or 550 to 3000 or 750 to 2500. Succinimide dispersants and their preparation are disclosed, for instance in U.S. Pat. Nos. 3,172,892, 3,219,666, 3,316,177, 3,340,281, 3,351,552, 3,381,022, 3,433,744, 3,444,170, 3,467,668, 3,501,405, 3,542,680, 3,576,743, 3,632,511, 4,234,435, Re 26,433, and 6,165,235, 7,238,650 and EP Patent 0 355 895B1.

The dispersant may also be post-treated by conventional methods by a reaction with any of a variety of agents. Among these are boron compounds, urea, thiourea, dimercaptothiadiazoles, carbon disulfide, aldehydes, ketones, carboxylic acids, hydrocarbon-substituted succinic anhydrides, maleic anhydride, nitriles, epoxides, and phosphorus compounds.

The dispersant may be borated using one or more of a variety of agents selected from the group consisting of the various forms of boric acid (including metaboric acid, HBO₂, orthoboric acid, H₃BO₃, and tetraboric acid, H₂B₄O₇), boric oxide, boron trioxide, and alkyl borates. In one embodiment the borating agent is boric acid which may be used alone or in combination with other borating agents. Methods of preparing borated dispersants are known in the art. The borated dispersant may be prepared in such a way that they contain 0.1 weight % to 2.5 weight% boron, or 0.1 weight % to 2.0 weight % boron or 0.2 to 1.5 weight % boron or 0.3 to 1.0 weight % boron.

Suitable polyisobutylenes for use in the succinimide dispersant may include those formed from polyisobutylene or highly reactive polyisobutylene having at least about 50 mol %, such as about 60 mol %, and particularly from about 70 mol % to about 90 mol % or greater than 90 mol%, terminal vinylidene content. Suitable polyisobutenes may include those prepared using BF₃ catalysts. In one embodiment, the borated dispersant is derived from a polyolefin having number average molecular weight of 350 to 3000 Daltons and a vinylidene content of at least 50 mol %, or at least 70 mol %, or at least 90 mol %.

The dispersant may be prepared/obtained/obtainable from reaction of succinic anhydride by an “ene” or “thermal” reaction, by what is referred to as a “direct alkylation process.” The “ene” reaction mechanism and general reaction conditions are summarized in “Maleic Anhydride”, pages, 147-149, Edited by B. C. Trivedi and B. C. Culbertson and Published by Plenum Press in 1982. The dispersant prepared by a process that includes an “ene” reaction may be a polyisobutylene succinimide having a carbocyclic ring present on less than 50 mole %, or 0 to less than 30 mole %, or 0 to less than 20 mole %, or 0 mole % of the dispersant molecules. The “ene” reaction may have a reaction temperature of 180° C. to less than 300° C., or 200° C. to 250° C., or 200° C. to 220° C.

The dispersant may also be obtained/obtainable from a chlorine-assisted process, often involving Diels-Alder chemistry, leading to formation of carbocyclic linkages. The process is known to a person skilled in the art. The chlorine-assisted process may produce a dispersant that is a polyisobutylene succinimide having a carbocyclic ring present on 50 mole % or more, or 60 to 100 mole % of the dispersant molecules. Both the thermal and chlorine-assisted processes are described in greater detail in U.S. Pat. No. 7,615,521, columns 4-5 and preparative examples A and B.

The dispersant may be used alone or as part of a mixture of non-borated and borated dispersants. If a mixture of dispersants is used, there may be two to five, or two to three or two dispersants.

The polyolefin dispersant may comprise a polyalphaolefins (PAO) containing dispersant selected from the group consisting of a polyalphaolefin succinimide, a polyalphaolefin succinamide, a polyalphaolefin acid ester, a polyalphaolefin oxazoline, a polyalphaolefin imidazoline, a polyalphaolefin succinamide imidazoline, and combinations thereof.

Polyalphaolefins (PAO) useful as feedstock in forming the PAO containing dispersants are those derived from oligomerization or polymerization of ethylene, propylene, and a-olefins. Suitable a-olefins include 1-butene, 1-pentene, 1-hexene, 1-heptene, 1-octene, 1-nonene, 1-decene, 1-undecene, 1-dodecene, 1-tetradecene, and 1-octadecene. Feedstocks containing a mixture of two or more of the foregoing monomers as well as other hydrocarbons are typically employed when manufacturing PAOs commercially. The PAO may take the form of dimers, trimers, tetramers, polymers, and the like.

The PAO may be reacted with maleic anhydride (MA) to form the polyalphaolefin succinic anhydride (PAO-SA) and subsequently the anhydride may be reacted with one or more of polyamines, aminoalcohols, and alcohols/polyols to form polyalphaolefin succinimide, polyalphaolefin succinamide, polyalphaolefin succinic acid ester, polyalphaolefin oxazoline, polyalphaolefin imidazoline, polyalphaolefin- succinamide-imidazoline, and mixtures thereof.

The polyolefin dispersant may be present at 0.01 wt % to 20 wt %, or 0.1 wt % to 15 wt %, or 0.1 wt % to 10 wt %, or 1 wt % to 6 wt % of the composition.

ENGINE OILS: When present, the polyolefin dispersant may be present in a composition, at 0.01 wt % to 12 wt % or 0.1 wt % to 8 wt % or 0.5 wt % to 6 wt % of the composition.

DRIVELINE: When present, the polyolefin dispersant may be present in a composition, at 0.1 wt % to 10 wt % or 0.1 wt % to 8 wt % or 1 wt % to 6 wt % or 0 wt % to 5 wt % of the composition.

INDUSTRIAL: When present, the polyolefin dispersant may be present in a composition, at 0.001 wt % to 2 wt % or 0.005 wt % to 1.5 wt % or 0.01 wt % to 1.0 wt % of the composition. In some embodiments when the lubricating composition is a Hydraulics Oil the polyolefin dispersant may be present at 0 wt % to 2 wt %, or 0.01 wt % to 2.0 wt %, 0.05 wt % to 1.5 wt %, or 0.005 wt % to 1 wt %, or 0.05 wt % to 0.5 wt % of the overall composition.

FUEL: When present, the polyolefin dispersant may be present in a composition, at 0 to 500 ppm, or 0 to 250 ppm, or 0 to 100 ppm, or 5 to 250 ppm, or 5 to 100 ppm, or 10 to 100 ppm of the composition.

### Detergents for Fuel

Another class of ashless dispersant is Mannich bases. These are materials which are formed by the condensation of a higher molecular weight, alkyl substituted phenol, an alkylene polyamine, and an aldehyde such as formaldehyde and are described in more detail in U.S. Pat. No. 3,634,515.

A useful nitrogen containing dispersant includes the product of a Mannich reaction between (a) an aldehyde, (b) a polyamine, and (c) an optionally substituted phenol. The phenol may be substituted such that the Mannich product has a molecular weight of less than 7500. Optionally, the molecular weight may be less than 2000, less than 1500, less than 1300, or for example, less than 1200, less than 1100, less than 1000. In some embodiments, the Mannich product has a molecular weight of less than 900, less than 850, or less than 800, less than 500, or less than 400. The substituted phenol may be substituted with up to 4 groups on the aromatic ring. For example, it may be a tri or di - substituted phenol. In some embodiments, the phenol may be a mono-substituted phenol. The substitution may be at the ortho, and/or meta, and/or para position(s). To form the Mannich product, the molar ratio of the aldehyde to amine is from 4:1 to 1:1 or, from 2:1 to 1:1. The molar ratio of the aldehyde to phenol may be at least 0.75:1 ; preferably from 0.75 to 1 to 4:1, preferably 1:1 to 4:1 more preferably from 1:1 to 2:1. To form the preferred Mannich product, the molar ratio of the phenol to amine is preferably at least 1.5:1, more preferably at least 1.6:1, more preferably at least 1.7:1, for example at least 1.8:1, preferably at least 1.9:1. The molar ratio of phenol to amine may be up to 5:1 ; for example it may be up to 4:1, or up to 3.5:1. Suitably it is up to 3.25:1, up to 3:1, up to 2.5:1, up to 2.3:1 or up to 2.1:1.

Other dispersants include polymeric dispersant additives, which are generally hydrocarbon-based polymers which contain polar functionality to impart dispersancy characteristics to the polymer. An amine is typically employed in preparing the high TBN nitrogen-containing dispersant. One or more poly(alkyleneamine)s may be used, and these may comprise one or more poly(ethyleneamine)s having 3 to 5 ethylene units and 4 to 6 nitrogen units. Such materials include triethylenetetramine (TETA), tetraethylenepentamine (TEPA), and pentaethylenehexamine (PEHA). Such materials are typically commercially available as mixtures of various isomers containing a range number of ethylene units and nitrogen atoms, as well as a variety of isomeric structures, including various cyclic structures. The poly(alkyleneamine) may likewise comprise relatively higher molecular weight amines known in the industry as ethylene amine still bottoms.

In an embodiment, the fuel composition can comprise quaternary ammonium salts. The quaternary ammonium salts can comprise (a) a compound comprising (i) at least one tertiary amino group as described above, and (ii) a hydrocarbyl-substituent having a number average molecular weight of 100 to 5000, or 250 to 4000, or 100 to 4000 or 100 to 2500 or 3000; and (b) a quaternizing agent suitable for converting the tertiary amino group of (a)(i) to a quaternary nitrogen, as described above. The other quaternary ammonium salts are more thoroughly described in U.S. Pat. Nos. 7,951,211, issued May 31, 2011, and 8,083,814, issued Dec. 27, 2011, and U.S. Publication Nos. 2013/0118062, published May 16, 2013, 2012/0010112, published Jan. 12, 2012, 2013/0133243, published May 30, 2013, 2008/0113890, published May 15, 2008, and 2011/0219674, published Sep. 15, 2011, US 2012/0149617 published May 14, 2012, US 2013/0225463 published Aug. 29, 2013, US 2011/0258917 published Oct. 27, 2011, US 2011/0315107 published Dec. 29, 2011, US 2013/0074794 published Mar. 28, 2013, US 2012/0255512 published Oct. 11, 2012, US 2013/0333649 published Dec. 19, 2013, US 2013/0118062 published May 16, 2013, and international publications WO Publication Nos. 2011/141731, published Nov. 17, 2011, 2011/095819, published Aug. 11, 2011, and 2013/017886, published Feb. 7, 2013, WO 2013/070503 published May 16, 2013, WO 2011/110860 published Sep. 15, 2011, WO 2013/017889 published Feb. 7, 2013, WO 2013/017884 published Feb. 7, 2013.

The quaternary ammoniums salts can be prepared from hydrocarbyl substituted acylating agents, such as, for example, polyisobutyl succinic acids or anhydrides, having a hydrocarbyl substituent with a number average molecular weight of greater than 1200 Mₙ, polyisobutyl succinic acids or anhydrides, having a hydrocarbyl substituent with a number average molecular weight of 300 to 750, or polyisobutyl succinic acids or anhydrides, having a hydrocarbyl substituent with a number average molecular weight of 1000 Mₙ.

In an embodiment, the additional salts may be an imide prepared from the reaction of a nitrogen containing compound and a hydrocarbyl substituted acylating agent having a hydrocarbyl sub stituent with a number average molecular weight of 1300 to 3000. In an embodiment, the quaternary ammonium salts prepared from the reaction of nitrogen containing compound and a hydrocarbyl substituted acylating agent having a hydrocarbyl substituent with a number average molecular weight of greater than 1200 Mₙ or, having a hydrocarbyl substituent with a number average molecular weight of 300 to 750 is an amide or ester.

In an embodiment, the nitrogen containing compound of the additional quaternary ammonium salts is an imidazole or nitrogen containing compound of either of formulas:

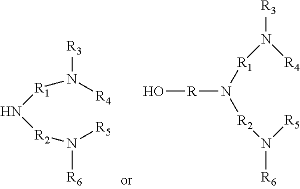

wherein R may be a Ci to C₆ alkylene group; each of Ri and R₂, individually, may be a Ci to C₆ hydrocarbylene group; and each of R₃, R₄, R5, and R5, individually, may be a hydrogen or a Ci to C₆ hydrocarbyl group.

In other embodiments, the quaternizing agent used to prepare the additional quaternizing ammonium salts can be a dialkyl sulfate, an alkyl halide, a hydrocarbyl substituted carbonate, a hydrocarbyl epoxide, a carboxylate, alkyl esters, or mixtures thereof. In some cases, the quaternizing agent can be a hydrocarbyl epoxide. In some cases, the quaternizing agent can be a hydrocarbyl epoxide in combination with an acid. In some cases, the quaternizing agent can be a salicylate, oxalate or terephthalate. In an embodiment, the hydrocarbyl epoxide is an alcohol functionalized epoxides or C₄ to C₁₄ epoxides.

In some embodiments, the quaternizing agent is multi-functional resulting in the additional quaternary ammonium salts being a coupled quaternary ammoniums salts. Typical treat rates of additional detergents/dispersants to a fuel of the invention is 0 to 500 ppm, or 0 to 250 ppm, or 0 to 100 ppm, or 5 to 250 ppm, or 5 to 100 ppm, or 10 to 100 ppm.

### Metal-Containing Detergent

A composition prepared according to the instantly disclosed process may further include a metal-containing detergent. Metal-containing detergents are well known in the art. They are generally made up of metal salts, especially alkali metals and alkaline earth metals, of acidic organic substrates. Metal-containing detergents may be neutral, i.e. a stoichiometric salt of the metal and substrate also referred to as neutral soap or soap, or overbased.

Metal overbased detergents, otherwise referred to as overbased detergents, metal-containing overbased detergents or superbased salts, are characterized by a metal content in excess of that which would be necessary for neutralization according to the stoichiometry of the metal and the particular acidic organic compound, i.e. the substrate, reacted with the metal. The overbased detergent may comprise one or more of non-sulfur containing phenates, sulfur containing phenates, sulfonates, salicylates, and mixtures thereof.

The amount of excess metal is commonly expressed in terms of substrate to metal ratio. The terminology “metal ratio” is used in the prior art and herein to define the ratio of the total chemical equivalents of the metal in the overbased salt to the chemical equivalents of the metal in the salt which would be expected to result from the reaction between the hydrocarbyl substituted organic acid; the hydrocarbyl-substituted phenol or mixtures thereof to be overbased, and the basic metal compound according to the known chemical reactivity and the stoichiometry of the two reactants. Thus, in a normal or neutral salt (i.e., soap) the metal ratio is one and, in an overbased salt, the metal ratio is greater than one, especially greater than 1.3. The overbased metal detergent may have a metal ratio of 5 to 30, or a metal ratio of 7 to 22, or a metal ratio of at least 11.

The metal-containing detergent may also include “hybrid” detergents formed with mixed surfactant systems including phenate and/or sulfonate components, e.g. phenate-salicylates, sulfonate-phenates, sulfonate-salicylates, sulfonates-phenates-salicylates, as described, for example, in U.S. Pat. Nos. 6,429,178; 6,429,179; 6,153,565; and 6,281,179. Where, for example, a hybrid sulfonate/phenate detergent is employed, the hybrid detergent would be considered equivalent to amounts of distinct phenate and sulfonate detergents introducing like amounts of phenate and sulfonate soaps, respectively. Overbased phenates and salicylates typically have a total base number of 180 to 450 TBN. Overbased sulfonates typically have a total base number of 250 to 600, or 300 to 500. Overbased detergents are known in the art.

Alkylphenols are often used as constituents in and/or building blocks for overbased detergents. Alkylphenols may be used to prepare phenate, salicylate, salixarate, or saligenin detergents or mixtures thereof. Suitable alkylphenols may include para-substitued hydrocarbyl phenols. The hydrocarbyl group may be linear or branched aliphatic groups of 1 to 60 carbon atoms, 8 to 40 carbon atoms, 10 to 24 carbon atoms, 12 to 20 carbon atoms, or 16 to 24 carbon atoms. In one embodiment, the alkylphenol overbased detergent is prepared from an alkylphenol or mixture thereof that is free of or substantially free of (i.e. contains less than 0.1 weight percent) p-dodecylphenol. In one embodiment, the lubricating composition contains less than 0.3 weight percent of alkylphenol, less than 0.1 weight percent of alkylphenol, or less than 0.05 weight percent of alkylphenol.

The overbased metal-containing detergent may be alkali metal or alkaline earth metal salts. In one embodiment, the overbased detergent may be sodium salts, calcium salts, magnesium salts, or mixtures thereof of the phenates, sulfur-containing phenates, sulfonates, salixarates and salicylates. In one embodiment, the overbased detergent is a calcium detergent, a magnesium detergent or mixtures thereof. In one embodiment, the overbased calcium detergent may be present in an amount to deliver at least 500 ppm calcium by weight and no more than 3000 ppm calcium by weight, or at least 1000 ppm calcium by weight, or at least 2000 ppm calcium by weight, or no more than 2500 ppm calcium by weight to the lubricating composition. In one embodiment, the overbased detergent may be present in an amount to deliver no more than 500 ppm by weight of magnesium to the lubricating composition, or no more than 330 ppm by weight, or no more than 125 ppm by weight, or no more than 45 ppm by weight. In one embodiment, the lubricating composition is essentially free of (i.e. contains less than 10 ppm) magnesium resulting from the overbased detergent. In one embodiment, the overbased detergent may be present in an amount to deliver at least 200 ppm by weight of magnesium, or at least 450 ppm by weight magnesium, or at least 700 ppm by weight magnesium to the lubricating composition. In one embodiment, both calcium and magnesium containing detergents may be present in the lubricating composition. Calcium and magnesium detergents may be present such that the weight ratio of calcium to magnesium is 10:1 to 1:10, or 8:3 to 4:5, or 1:1 to 1:3. In one embodiment, the overbased detergent is free of or substantially free of sodium.

In one embodiment, the sulfonate detergent may be predominantly a linear alkylbenzene sulfonate detergent having a metal ratio of at least 8 as is described in paragraphs [0026] to [0037] of US Patent Publication 2005/065045 (and granted as U.S. Pat. No. 7,407,919). The linear alkylbenzene sulfonate detergent may be particularly useful for assisting in improving fuel economy. The linear alkyl group may be attached to the benzene ring anywhere along the linear chain of the alkyl group, but often in the 2, 3 or 4 position of the linear chain, and in some instances, predominantly in the 2 position, resulting in the linear alkylbenzene sulfonate detergent.

Salicylate detergents and overbased salicylate detergents may be prepared in at least two different manners. Carbonylation (also referred to as carboxylation) of a p-alkylphenol is described in many references including U.S. Pat. No. 8,399,388. Carbonylation may be followed by overbasing to form overbased salicylate detergent. Suitable p-alkylphenols include those with linear and/or branched hydrocarbyl groups of 1 to 60 carbon atoms. Salicylate detergents may also be prepared by alkylation of salicylic acid, followed by overbasing, as described in U.S. Pat. No. 7,009,072. Salicylate detergents prepared in this manner, may be prepared from linear and/or branched alkylating agents (usually 1-olefins) containing 6 to 50 carbon atoms, 10 to 30 carbon atoms, or 14 to 24 carbon atoms. In one embodiment, the overbased detergent is a salicylate detergent. In one embodiment, the salicylate detergent is free of unreacted p-alkylphenol (i.e. contains less than 0.1 weight percent). In one embodiment, the salicylate detergent is prepared by alkylation of salicylic acid.

The metal-containing overbased detergents may be present at 0.2 wt % to 15 wt %, or 0.3 wt % to 10 wt %, or 0.3 wt % to 8 wt %, or 0.4 wt % to 3 wt % of a composition. For example, in a heavy-duty diesel engine, the detergent may be present at 2 wt % to 3 wt % of the lubricating composition. For a passenger car engine, the detergent may be present at 0.2 wt % to 1 wt % of the lubricating composition.

ENGINE OILS: When present, the metal-containing overbased detergents may be present in a composition, at 0.01 wt % to 9 wt % or 0.5 wt % to 8 wt % or 1 wt % to 5 wt % of the composition.

DRIVELINE: In an automotive gear oil, for example the detergent may be present in the lubrication composition in an amount of 0.05 wt % to 1 wt %, or 0.1 wt % to 0.9 wt %. In a manual transmission fluid, for example, the detergent may be present in the lubricating composition in an amount of at least 0.1 wt %, 0.14 wt % to 4 wt %, or 0.2 wt % to 3.5 wt %, or 0.5 wt % to 3 wt %, or 1 wt % to 2 wt %, or 0.5 wt % to 4 wt %, or 0.6 wt % to 3.5 wt %, or 1 wt % to 3 wt %, or at least 1 wt %, e.g., 1.5wt % to 2.8 wt %

INDUSTRIAL: When present, the metal-containing overbased detergents may be present in a composition, at 0.001 wt % to 5 wt % or 0.001wt % to 1.5wt % or 0.005 wt % to 1.0 wt % of the composition.

GREASE: When present, the detergent may be present at 0.001 wt % to 6 wt %, or 0.01 wt % to 4 wt %, or 0.05 wt % to 2 wt %, or 0.1 wt % to 2 wt % of the grease composition, for example, where the detergent is a metal-containing detergent other than an overbased metal-containing detergent, or alternatively 0 wt % to 2 wt %, or 0.05 wt % to 1.5 wt %, or 0.1 wt % to 1 wt % of the grease composition, for example, where the detergent is an overbased metal -containing detergent.

Metal-containing detergents contribute sulfated ash to a lubricating composition. Sulfated ash may be determined by ASTM D874. In one embodiment, the lubricating composition comprises a metal-containing detergent in an amount to deliver at least 0.4 weight percent sulfated ash to the total composition. In another embodiment, the metal-containing detergent is present in an amount to deliver at least 0.6 weight percent sulfated ash, or at least 0.75 weight percent sulfated ash, or even at least 0.9 weight percent sulfated ash to the lubricating composition. In one embodiment, the metal-containing overbased detergent is present in an amount to deliver 0.1 weight percent to 0.8 weight percent sulfated ash to the lubricating composition.

In addition to ash and TBN, overbased detergents contribute detergent soap, also referred to as neutral detergent salt, to the lubricating composition. Soap, being a metal salt of the substrate, may act as a surfactant in the lubricating composition. In one embodiment, the lubricating composition comprises 0.05 weight percent to 1.5 weight percent detergent soap, or 0.1 weight percent to 0.9 weight percent detergent soap. In one embodiment, the lubricating composition contains no more than 0.5 weight percent detergent soap. The overbased detergent may have a weight ratio of ash:soap of 5:1 to 1:2.3, or 3.5:1 to 1:2, or 2.9:1 to 1:1:7.

### Polymeric Viscosity Modifier

A composition prepared according to the instant disclosure may contain a polymeric viscosity modifier, a dispersant viscosity modifier, or combinations thereof. The dispersant viscosity modifier may be generally understood to be a functionalized, i.e. derivatized, form of a polymer similar to that of the polymeric viscosity modifier.

The polymeric viscosity modifier may be an olefin (co)polymer, a poly(meth)acrylate (PMA), or mixtures thereof. In one embodiment, the polymeric viscosity modifier is an olefin (co)polymer.

The olefin polymer may be derived from isobutylene or isoprene. In one embodiment, the olefin polymer is prepared from ethylene and a higher olefin within the range of C3-C10 alpha-mono-olefins, for example, the olefin polymer may be prepared from ethylene and propylene.

In one embodiment, the olefin polymer may be a polymer of 15 to 80 mole percent of ethylene, for example, 30 mol percent to 70 mol percent ethylene and from and from 20 to 85 mole percent of C3 to C10 mono-olefins, such as propylene, for example, 30 to 70 mol percent propylene or higher mono-olefins. Terpolymer variations of the olefin copolymer may also be used and may contain up to 15 mol percent of a non-conjugated diene or triene. Non-conjugated dienes or trienes may have 5 to about 14 carbon atoms. The non-conjugated diene or triene monomers may be characterized by the presence of a vinyl group in the structure and can include cyclic and bicycle compounds. Representative dienes include 1,4-hexadiene, 1,4-cyclohexadiene, dicyclopentadiene, 5-ethyldiene-2-norbornene, 5-methylene-2-norbornene, 1,5-heptadiene, and 1,6-octadiene.

In one embodiment, the olefin copolymer may be a copolymer of ethylene, propylene, and butylene. The polymer may be prepared by polymerizing a mixture of monomers comprising ethylene, propylene and butylene. These polymers may be referred to as copolymers or terpolymers. The terpolymer may comprise from about 5 mol % to about 20 mol %, or from about 5 mol % to about 10 mol % structural units derived from ethylene; from about 60 mol % to about 90 mol %, or from about 60 mol % to about 75 mol structural units derived from propylene; and from about 5 mol % to about 30 mol %, or from about 15 mol % to about 30 mol % structural units derived from butylene. The butylene may comprise any isomers or mixtures thereof, such as n-butylene, iso-butylene, or a mixture thereof. The butylene may comprise butene-1. Commercial sources of butylene may comprise butene-1 as well as butene-2 and butadiene. The butylene may comprise a mixture of butene-1 and isobutylene wherein the weight ratio of butene-1 to isobutylene is about 1:0.1 or less. The butylene may comprise butene-1 and be free of or essentially free of isobutylene.

In one embodiment, the olefin copolymer may be a copolymer of ethylene and butylene. The polymer may be prepared by polymerizing a mixture of monomers comprising ethylene and butylene wherein, the monomer composition is free of or substantially free of propylene monomers (i.e. contains less than 1 weight percent of intentionally added monomer). The copolymer may comprise 30 to 50 mol percent structural units derived from butylene; and from about 50 mol percent to 70 mol percent structural units derived from ethylene. The butylene may comprise a mixture of butene-1 and isobutylene wherein the weight ratio of butene-1 to isobutylene is about 1:0.1 or less. The butylene may comprise butene-1 and be free of or essentially free of isobutylene.

Useful olefin polymers, in particular, ethylene-α-olefin copolymers have a number average molecular weight ranging from 4500 to 500,000, for example, 5000 to 100,000, or 7500 to 60,000, or 8000 to 45,000.

The formation of functionalized ethylene-α-olefin copolymer is well known in the art, for instance those described in U.S. Pat. No. 7,790,661 column 2, line 48 to column 10, line 38. Additional detailed descriptions of similar functionalized ethylene-α-olefin copolymers are found in International Publication WO2006/015130 or U.S. Pat. Nos. 4,863,623; 6,107,257; 6,107,258; 6,117,825; and 7,790,661. In one embodiment the functionalized ethylene-α-olefin copolymer may include those described in U.S. Pat. No. 4,863,623 (see column 2, line 15 to column 3, line 52) or in International Publication WO2006/015130 (see page 2, paragraph [0008] and preparative examples are described paragraphs [0065] to [0073]).

In one embodiment, the lubricating composition comprises a dispersant viscosity modifier (DVM). The DVM may comprise an olefin polymer that has been modified by the addition of a polar moiety.

The olefin polymers are functionalized by modifying the polymer by the addition of a polar moiety. In one useful embodiment, the functionalized copolymer is the reaction product of an olefin polymer grafted with an acylating agent. In one embodiment, the acylating agent may be an ethylenically unsaturated acylating agent. Useful acylating agents are typically α,β unsaturated compounds having at least one ethylenic bond (prior to reaction) and at least one, for example two, carboxylic acid (or its anhydride) groups or a polar group which is convertible into said carboxyl groups by oxidation or hydrolysis. The acylating agent grafts onto the olefin polymer to give two carboxylic acid functionalities. Examples of useful acylating agents include maleic anhydride, chlormaleic anhydride, itaconic anhydride, or the reactive equivalents thereof, for example, the corresponding dicarboxylic acids, such as maleic acid, fumaric acid, cinnamic acid, (meth)acrylic acid, the esters of these compounds and the acid chlorides of these compounds.

In one embodiment, the functionalized ethylene-α-olefin copolymer comprises an olefin copolymer grafted with the acyl group which is further functionalized with a hydrocarbyl amine, a hydrocarbyl alcohol group, amino- or hydroxy-terminated polyether compounds, and mixtures thereof.

Amine functional groups may be added to the olefin polymer by reacting the olefin copolymer (typically, an ethylene-α-olefin copolymer, such as an ethylene-propylene copolymer) with an acylating agent (typically maleic anhydride) and a hydrocarbyl amine having a primary or secondary amino group. In one embodiment, the hydrocarbyl amine may be selected from aromatic amines, aliphatic amines, and mixtures thereof.

In one embodiment, the hydrocarbyl amine component may comprise at least one aromatic amine containing at least one amino group capable of condensing with said acyl group to provide a pendant group and at least one additional group comprising at least one nitrogen, oxygen, or sulfur atom, wherein said aromatic amine is selected from the group consisting of (i) a nitro-substituted aniline, (ii) an amine comprising two aromatic moieties linked by a C(O)NR- group, a —C(O)O— group, an —O— group, an N═N— group, or an —SO2- group where R is hydrogen or hydrocarbyl, one of said aromatic moieties bearing said condensable amino group, (iii) an aminoquinoline, (iv) an aminobenzimidazole, (v) an N,N- dialkylphenylenediamine, (vi), an aminodiphenylamine (also N,N-phenyldiamine), and (vii) a ring-substituted benzylamine.

In one embodiment, the hydrocarbyl amine component may comprise at least one aliphatic amine containing at least one amino group capable of condensing with said acyl group to provide a pendant group and at least one additional group comprising at least one nitrogen, oxygen, or sulfur atom. Suitable aliphatic amines include polyethylene polyamines (such as tetraethylene pentamine (TEPA), triethylene tetra amine (TETA), pentaethylene hexamine (PEHA), and polyamine bottoms), N,N-dimethylaminopropylamine (DMAPA), N-(aminopropyl)morpholine, N,N-diIsostearylaminopropylamine, ethanolamine, and combinations thereof.

In another one embodiment, the polar moiety added to the functionalized ethylene-α-olefin copolymer may be derived from a hydrocarbyl alcohol group, containing at least one hydroxy group capable of condensing with said acyl group to provide a pendant group and at least one additional group comprising at least one nitrogen, oxygen, or sulfur atom. The alcohol functional groups may be added to the olefin polymer by reacting the olefin copolymer with an acylating agent (typically maleic anhydride) and a hydrocarbyl alcohol. The hydrocarbyl alcohol may be a polyol compound. Suitable hydrocarbyl polyols include ethylene glycol and propylene glycol, trimethylol propane (TMP), pentaerythritol, and mixtures thereof.

In another one embodiment, the polar moiety added to the functionalized ethylene-α-olefin copolymer may be amine-terminated polyether compounds, hydroxy-terminated polyether compounds, and mixtures thereof. The hydroxy terminated or amine terminated polyether may be selected from the group comprising polyethylene glycols, polypropylene glycols, mixtures of one or more amine terminated polyether compounds containing units derived from ethylene oxides, propylene oxides, butylene oxides or some combination thereof, or some combination thereof. Suitable polyether compounds include Synalox® line of polyalkylene glycol compounds, the UCON™ OSP line of polyether compounds available from Dow Chemical, Jeffamine® line of polyether amines available from Huntsman.

In one embodiment, lubricating composition may comprise a poly(meth)acrylate polymeric viscosity modifier. As used herein, the term “(meth)acrylate” and its cognates means either methacrylate or acrylate, as will be readily understood.

In one embodiment, the poly(meth)acrylate polymer is prepared from a monomer mixture comprising (meth)acrylate monomers having alkyl groups of varying length. The (meth)acrylate monomers may contain alkyl groups that are straight chain or branched chain groups. The alkyl groups may contain 1 to 24 carbon atoms, for example 1 to 20 carbon atoms.

The poly(meth)acrylate polymers described herein are formed from monomers derived from saturated alcohols, such as methyl (meth)acrylate, ethyl (meth)acrylate, propyl (meth)acrylate, butyl (meth)acrylate, 2-methylpentyl (meth)acrylate, 2-propylheptyl (meth)acrylate, 2-butyloctyl (meth)acrylate, 2-ethylhexyl (meth)acrylate, octyl (meth)acrylate, nonyl (meth)acrylate, isooctyl (meth)acrylate, isononyl (meth)acrylate, 2-tert-butylheptyl (meth)acrylate, 3-isopropylheptyl (meth)acrylate, decyl (meth)acrylate, undecyl (meth)acrylate, 5-methylundecyl (meth)acrylate, dodecyl (meth)acrylate, 2-methyldodecyl (meth)acrylate, tridecyl (meth)acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl-(meth)acrylate, octadecyl (meth)acrylate, nonadecyl (meth)acrylate, eicosyl (meth)acrylate, (meth)acrylates derived from unsaturated alcohols, such as oleyl (meth)acrylate; and cycloalkyl (meth)acrylates, such as 3-vinyl-2-butylcyclohexyl (meth)acrylate or bornyl (meth)acrylate.

Other examples of monomers include alkyl (meth)acrylates with long-chain alcohol-derived groups which may be obtained, for example, by reaction of a (meth)acrylic acid (by direct esterification) or methyl (meth)acrylate (by transesterification) with long-chain fatty alcohols, in which reaction a mixture of esters such as (meth)acrylate with alcohol groups of various chain lengths is generally obtained. These fatty alcohols include Oxo Alcohol® 7911, Oxo Alcohol® 7900 and Oxo Alcohol® 1100 of Monsanto; Alphanol® 79 of ICI; Nafol® 1620, Alfol® 610 and Alfol® 810 of Condea (now Sasol); Epal® 610 and Epal® 810 of Ethyl Corporation; Linevol® 79, Linevol® 911 and Dobanol® 25 L of Shell AG; Lial® 125 of Condea Augusta, Milan; Dehydad® and Lorol® of Henkel KGaA (now Cognis) as well as Linopol® 7-11 and Acropol® 91 of Ugine Kuhlmann.

In one embodiment, the poly(meth)acrylate polymer comprises a dispersant monomer; dispersant monomers include those monomers which may copolymerize with (meth)acrylate monomers and contain one or more heteroatoms in addition to the carbonyl group of the (meth)acrylate. The dispersant monomer may contain a nitrogen-containing group, an oxygen-containing group, or mixtures thereof.

The oxygen-containing compound may include hydroxyalkyl(meth)acrylates such as 3-hydroxypropyl(meth)acrylate, 3,4-dihydroxybutyl(meth)acrylate, 2-hydroxyethylethyl(meth)acrylate, 2-hydroxypropyl(meth)acryl ate, 2,5 - dimethyl -1,6-hexanediol (meth)acrylate, 1, 10-decanediol(meth)acrylate, carbonyl -containing (meth)acrylates such as 2 -carboxy ethyl(meth)acrylate, carboxymethyl(meth)acrylate, oxazolidinylethyl(meth)acrylate, N-(methacryloyloxy)formamide, acetonyl(meth)acrylate, N-methacryloylmorpholine, N-methacryloyl-2-pyrrolidinone, N-(2-methacryloyl-oxyethyl)-2-pyrrolidinone, N-(3 -methacryloyloxypropyl)-2-pyrrolidinone, N-(2-methacryloyloxypentadecyl)-2-pyrrolidinone, N-(3-methacryloyloxy-heptadecyl)-2-pyrrolidinone; glycol di(meth)acrylates such as 1,4-butanediol(meth)acrylate, 2-butoxyethyl(meth)acrylate, 2-ethoxyethoxymethyl(meth)acrylate, 2-ethoxyethyl(meth)acrylate, or mixtures thereof.

The nitrogen-containing compound may be a (meth)acrylamide or a nitrogen containing (meth)acrylate monomer. Examples of a suitable nitrogen-containing compound include N,N-dimethylacrylamide, N-vinyl carbonamides such as N-vinyl-formamide, vinyl pyridine, N-vinylacetoamide, N-vinyl propionamides, N-vinyl hydroxy-acetoamide, N-vinyl imidazole, N-vinyl pyrrolidinone, N-vinyl caprolactam, dimethylaminoethyl acrylate (DMAEA), dimethylaminoethyl methacrylate (DMAEMA), dim ethylaminobutyl acrylamide, dim ethylaminopropyl meth-acrylate (DMAPMA), dimethylaminopropyl acrylamide, dimethyl-aminopropyl methacrylamide, dimethylaminoethyl acrylamide or mixtures thereof.

Dispersant monomers may be present in an amount up to 5 mol percent of the monomer composition of the (meth)acrylate polymer. In one embodiment, the poly(meth)acrylate is present in an amount 0 to 5 mol percent, 0.5 to 4 mol percent, or 0.8 to 3 mol percent of the polymer composition. In one embodiment, the poly(meth)acrylate is free of or substantially free of dispersant monomers.

In one embodiment, the poly(meth)acrylate comprises a block copolymer or tapered block copolymer. Block copolymers are formed from a monomer mixture comprising one or more (meth)acrylate monomers, wherein, for example, a first (meth)acrylate monomer forms a discrete block of the polymer joined to a second discrete block of the polymer formed from a second (meth)acrylate monomer. While block copolymers have substantially discrete blocks formed from the monomers in the monomer mixture, a tapered block copolymer may be composed of, at one end, a relatively pure first monomer and, at the other end, a relatively pure second monomer. The middle of the tapered block copolymer is more of a gradient composition of the two monomers.

In one embodiment, the poly(meth)acrylate polymer (P) is a block or tapered block copolymer that comprises at least one polymer block (B₁) that is insoluble or substantially insoluble in the base oil and a second polymer block (B₂) that is soluble or substantially soluble in the base oil.

In one embodiment, the poly(meth)acrylate polymers may have an architecture selected from linear, branched, hyper-branched, cross-linked, star (also referred to as “radial”), or combinations thereof. Star or radial refers to multi-armed polymers. Such polymers include (meth)acrylate-containing polymers comprising 3 or more arms or branches, which, in some embodiments, contain at least about 20, or at least 50 or 100 or 200 or 350 or 500 or 1000 carbon atoms. The arms are generally attached to a multivalent organic moiety which acts as a “core” or “coupling agent.” The multi-armed polymer may be referred to as a radial or star polymer, or even a “comb” polymer, or a polymer otherwise having multiple arms or branches as described herein.

Linear poly(meth)acrylates, random, block or otherwise, may have weight average molecular weight (M_{w}) of 1000 to 400,000 Daltons, 1000 to 150,000 Daltons, or 15,000 to 100,000 Daltons. In one embodiment, the poly(meth)acrylate may be a linear block copolymer with a Mw of 5,000 to 40,000 Daltons, or 10,000 to 30,000 Daltons.

Radial, cross-linked or star copolymers may be derived from linear random or di-block copolymers with molecular weights as described above. A star polymer may have a weight average molecular weight of 10,000 to 1,500,000 Daltons, or 40,000 to 1,000,000 Daltons, or 300,000 to 850,000 Daltons.

The polymeric viscosity modifiers and/or dispersant viscosity modifiers may be used in the functional fluids or lubricant compositions at a concentration of up to 20% or 60% or 70% by weight. Concentrations of 0.1 wt % to 12 wt % or 0.1 wt % to 4 wt %, or 0.2 wt % to 3 wt % or 1 wt % to 12 wt % or 3 wt % to 10 wt % may be used.

The lubricating compositions may comprise 0.05 wt % to 2 wt %, or 0.08 wt % to 1.8 wt %, or 0.1 wt % to 1.2 weight % of the one or more polymeric viscosity modifiers and/or dispersant viscosity modifiers as described herein.

ENGINE OILS: When present, the one or more polymeric viscosity modifiers and/or dispersant viscosity modifiers may be present in a composition, at 0.001 wt % to 10 wt %, or 0 wt % to 5 wt %, or 0 wt % to 4 wt %, or 0.05 wt % to 2 wt %, or 0.2 wt % to 1.2 wt % of the lubricant composition.

DRIVELINE: When present, the one or more polymeric viscosity modifiers and/or dispersant viscosity modifiers may be present in a composition, at 0.1 wt % to 70 wt % or 1 wt % to 60 wt % or 0.1 wt % to 40 wt % or 0.1 wt % to 15 wt % or 15 wt % to 70 wt % of the composition.

INDUSTRIAL: When present, the one or more polymeric viscosity modifiers and/or dispersant viscosity modifiers may be present in a composition, at 0.001 wt % to 10 wt % or 0.5 wt % to 8 wt % or 1.0 wt % to 6.0 wt % of the composition.

GREASE: When present, the one or more polymeric viscosity modifiers and or dispersant viscosity modifiers may be present at 0.001 wt % to 15 wt %, or 0 wt % to 10 wt %, or 0.05 wt % to 5 wt %, or 0.2 wt % to 2 wt % of the grease composition.

### Anti-Wear Agent

Compositions prepared according to the instant disclosure may optionally include at least one antiwear agent. Examples of suitable antiwear agents suitable for use herein include titanium compounds, tartrates, tartrimides, oil soluble amine salts of phosphorus compounds, sulfurized olefins, metal dihydrocarbyldithiophosphates (such as zinc dialkyldithiophosphates), phosphites (such as dibutyl phosphite), phosphonates, thiocarbamate-containing compounds, such as thiocarbamate esters, thiocarbamate amides, thiocarbamic ethers, alkylene-coupled thiocarbamates, and bis(S-alkyldithiocarbamyl) disulfides. The antiwear agent may in one embodiment include a tartrate, or tartrimide as described in U.S. Pub. Nos. 2006/0079413; 2006/0183647; and 2010/0081592. The tartrate or tartrimide may contain alkyl-ester groups, where the sum of carbon atoms on the alkyl groups is at least 8. The antiwear agent may, in one embodiment, include a citrate as is disclosed in US Pub. No. 2005/0198894.

A composition may in one embodiment further include a phosphorus-containing antiwear agent. Example phosphorus-containing antiwear agents include zinc dialkyldithiophosphates, phosphites, phosphates, phosphonates, and ammonium phosphate salts, and mixtures thereof.

Compositions disclosed herein may include one or more oil-soluble titanium compounds, which may function as antiwear agents, friction modifiers, antioxidants, deposit control additives, or more than one of these functions. Example oil-soluble titanium compounds are disclosed in U.S. Pat. No. 7,727,943 and U.S. Pub. No. 2006/0014651. Example oil soluble titanium compounds include titanium (IV) alkoxides, such as titanium (IV) isopropoxide and titanium (IV) 2 ethylhexoxide. Such alkoxides may be formed from a monohydric alcohol, a vicinal 1,2-diol, a polyol, or mixture thereof. The monohydric alkoxides may have 2 to 16, or 3 to 10 carbon atoms. In one embodiment, the titanium compound comprises the alkoxide of a vicinal 1,2-diol or polyol. 1,2-vicinal diols include fatty acid mono-esters of glycerol, where the fatty acid may be, for example, oleic acid. Other example oil soluble titanium compounds include titanium carboxylates, such as titanium neodecanoate.

When present in the composition, the amount of oil-soluble titanium compounds is included as part of the antiwear agent.

In another embodiment, the composition may have an antiwear additive comprising a phosphate amine salt. The C2-C18 (or C2 to C8 or C16-C18) di- or tri-hydrocarbyl phosphite, or mixtures thereof may be represented by the formula:

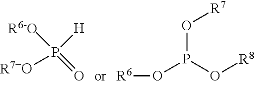

wherein at least one of R6, R7 and R8 may be a hydrocarbyl group containing at least 4 carbon atoms and the other may be hydrogen or a hydrocarbyl group. In one embodiment R6, R7 and R8 are all hydrocarbyl groups. The hydrocarbyl groups may be alkyl, cycloalkyl, aryl, acyclic or mixtures thereof. In the formula with all three groups R6, R7 and R8, the compound may be a tri-hydrocarbyl substituted phosphite i.e., R6, R7 and R8 are all hydrocarbyl groups and in some embodiments may be alkyl groups. Typically, the di- or tri-hydrocarbyl phosphite comprises dibutyl phosphite or oleyl phosphite.

The phosphorus-containing antiwear agent may include zinc dialkyldithiophosphate, a non-ionic phosphorus compound, which may be a hydrocarbyl phosphite; (i) a non-ionic phosphorus compound, which may be a hydrocarbyl phosphite; or (ii) an amine salt of a phosphorus compound, or mixtures thereof.

In one embodiment, the composition disclosed herein contains no zinc dialkyldithiophosphate. In one embodiment the lubricant composition disclosed herein contains zinc dialkyldithiophosphate. The phosphorus-containing compound may be a non-ionic phosphorus compound. In one embodiment the phosphorus-containing compounds comprise two or more (possibly up to four) non-ionic phosphorus compounds. Typically, the non-ionic phosphorus compound may have an oxidation of +3 or +5. The different embodiments comprise phosphite ester, phosphate esters, or mixtures thereof. In one embodiment the phosphorus-containing compound comprises a non-ionic phosphorus compound (a C₄₋₆ hydrocarbyl phosphite) and an amine salt of a phosphorus acid or ester.

In one embodiment, the phosphorus-containing compound comprises a non-ionic phosphorus compound that is a C₄₋₆ hydrocarbyl phosphite, or mixtures thereof. The C₄₋₆ hydrocarbyl phosphite includes those represented by the formula:

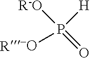

wherein each R′″ may be independently hydrogen or a hydrocarbyl group having 4 to 6 carbon atoms, typically 4 carbon atoms, with the proviso that at least one of the R′″ groups is hydrocarbyl. Typically, the C₄₋₆ hydrocarbyl phosphite comprises dibutyl phosphite.

The C₄₋₆ hydrocarbyl phosphite may deliver at least 175 ppm, or at least 200 ppm of the total amount of phosphorus delivered by the phosphorus-containing compounds.

The C₄₋₆ hydrocarbyl phosphite may deliver at least 45 wt %, or 50 wt % to 100 wt %, or 50 wt % to 90 wt % or 60 wt % to 80 wt % of the total amount of phosphorus from the phosphorus-containing compound.

The phosphorus-containing compounds may comprise a second phosphite whose formula is similar to that disclosed above, except R′″ may contain 2 to 40, 8 to 24 or 11 to 20 carbon atoms, with the proviso that the second phosphite is not a C₄₋₆ hydrocarbyl phosphite. Examples of suitable hydrocarbyl groups include propyl, dodecyl, butadecyl, hexadecyl, octadecyl, propenyl, dodecenyl, butadecenyl, hexadeencyl, or octadecenylgroups.

As used herein the term “alk(en)yl” is intended to include moieties that have an alkyl and/or alkenyl group.

In one embodiment, the phosphorus-containing compounds include a mixture of a C₄₋₆ hydrocarbyl phosphite (typically dibutyl phosphite) and a C₁₂₋₁₈ alk(en)yl hydrogen phosphite and optionally phosphoric acid. In different embodiments the phosphoric acid is present or absent.

In one embodiment, the phosphorus-containing compounds include a mixture of a C₄₋₆ hydrocarbyl phosphite (typically dibutyl phosphite) and a C₁₆₋₁₈ alk(en)yl hydrogen phosphite. The alk(en)yl hydrogen phosphite be may an alkyl hydrogen phosphite, and alkenyl hydrogen phosphite, or a mixture of alkenyl hydrogen phosphite and alkyl hydrogen phosphite. In one embodiment the alk(en)yl hydrogen phosphite be may a mixture of alkenyl hydrogen phosphite and alkyl hydrogen phosphite and optionally phosphoric acid. The phosphoric acid may be present or absent.

In one embodiment, the phosphorus-containing compounds include a mixture of a C₄₋₆ hydrocarbyl phosphite (typically dibutyl phosphite) and a C₁₁₋₁₄ alk(en)yl hydrogen phosphite. The alk(en)yl hydrogen phosphite be may an alkyl hydrogen phosphite, and alkenyl hydrogen phosphite, or a mixture of alkenyl hydrogen phosphite and alkyl hydrogen phosphite. In one embodiment the alk(en)yl hydrogen phosphite may be a mixture of alkenyl hydrogen phosphite and alkyl hydrogen phosphite and optionally phosphoric acid.

In one embodiment the phosphorus-containing compounds include a mixture of a C₄₋₆ hydrocarbyl phosphite (typically dibutyl phosphite) and phosphoric acid. The lubricant composition in one embodiment includes a package that comprises a phosphorus-containing compound and a non-ionic phosphorus compound that is a hydrocarbyl phosphite.

In one embodiment, the composition further comprises a C₈₋₂₀ hydrocarbyl phosphite, or a C₁₂₋₁₈ hydrocarbyl phosphite, or C₁₆₋₁₈ hydrocarbyl phosphite, as described above.

In on embodiment, the amine salt of a phosphorus acid may be derived from an amine salt of a phosphate. The amine salt of the phosphorus acid may be represented by the formula:

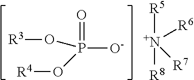

wherein R³ and R⁴ may be independently hydrogen or hydrocarbon typically containing 4 to 40, or 6 to 30, or 6 to 18, or 8 to 18 carbon atoms, with the proviso that at least one is a hydrocarbon group; and

R⁵, R⁶, R⁷ and R⁸ may be independently hydrogen or a hydrocarbyl group, with the proviso that at least one is a hydrocarbyl group.

The hydrocarbon groups of R³ and/or R⁴ may be linear, branched, or cyclic.

Examples of a hydrocarbon group for R³ and/or R⁴ include straight-chain or branched alkyl groups include methyl, ethyl, propyl, butyl, pentyl, hexyl, heptyl, octyl, nonyl, decyl, undecyl, dodecyl, tridecyl, tetradecyl, pentadecyl, hexadecyl, heptadecyl and octadecyl.

Examples of a cyclic hydrocarbon group for R³ and/or R⁴ include cyclopentyl, cyclohexyl, cycloheptyl, methylcyclopentyl, dimethylcyclopentyl, methylcyclopentyl, dimethylcyclopentyl, methylethylcyclopentyl, diethyl cyclopentyl, methylcyclohexyl, dimethylcyclohexyl, methylethylcyclohexyl, diethylcyclohexyl, methylcycloheptyl, dimethylcycloheptyl, methylethylcycloheptyl, and diethylcycloheptyl.

In one embodiment, the phosphate may be an amine salt of a mixture of monoalkyl and dialkyl phosphoric acid esters. The monoalkyl and dialkyl groups may be linear or branched.

The amine salt of a phosphorus acid may be derived from an amine such as a primary amine, a secondary amine, a tertiary amine, or mixtures thereof. The amine may be aliphatic, or cyclic, aromatic or non-aromatic, typically aliphatic. In one embodiment the amine includes an aliphatic amine such as a tertiary-aliphatic primary amine.

Examples of suitable primary amines include ethylamine, propylamine, butylamine, 2-ethylhexylamine, bis-(2-ethylhexyl)amine, octylamine, and dodecylamine, as well as such fatty amines as n-octylamine, n-decylamine, n-dodecylamine, n-tetradecylamine, n-hexadecylamine, n-octadecylamine and oleyamine. Other useful fatty amines include commercially available fatty amines such as “Armeen®” amines (products available from Akzo Chemicals, Chicago, Ill.), such as Armeen C, Armeen O, Armeen OL, Armeen T, Armeen HT, Armeen S and Armeen SD, wherein the letter designation relates to the fatty group, such as coco, oleyl, tallow, or stearyl groups.

Examples of suitable secondary amines include dimethylamine, diethylamine, dipropylamine, dibutylamine, diamylamine, dihexylamine, diheptylamine, methylethylamine, ethylbutylamine, N-methyl-1-amino-cyclohexane, Armeen® 2C and ethylamylamine. The secondary amines may be cyclic amines such as piperidine, piperazine and morpholine.

Examples of tertiary amines include tri-n-butylamine, tri-n-octylamine, tri-decylamine, tri-laurylamine, tri-hexadecylamine, and dimethyloleylamine (Armeen® DMOD).

In one embodiment, the amines are in the form of a mixture. Examples of suitable mixtures of amines include (i) a tertiary alkyl primary amine with 11 to 14 carbon atoms, (ii) a tertiary alkyl primary amine with 14 to 18 carbon atoms, or (iii) a tertiary alkyl primary amine with 18 to 22 carbon atoms. Other examples of tertiary alkyl primary amines include tert-butylamine, tert-hexylamine, tert-octylamine (such as 1,1-dimethylhexylamine), tert-decylamine (such as 1,1-dimethyloctylamine), tertdodecylamine, tert-tetradecylamine, tert-hexadecylamine, tert-octadecylamine, tert-tetracosanyl amine, and tert-octacosanylamine.

In one embodiment, a suitable mixture of amines is “Primene® 81R” or “Primene® JMT.” Primene® 81R and Primene® JMT (both produced and sold by Rohm & Haas) are mixtures of C11 to C14 tertiary alkyl primary amines and C18 to C22 tertiary alkyl primary amines respectively.

The amine salt of a phosphorus acid may be prepared as is described in U.S. Pat. No. 6,468,946. Column 10, lines 15 to 63 describes phosphoric acid esters formed by reaction of phosphorus compounds, followed by reaction with an amine to form an amine salt of a phosphate hydrocarbon ester. Column 10, line 64, to column 12, line 23, describes preparative examples of reactions between phosphorus pentoxide with an alcohol (having 4 to 13 carbon atoms), followed by a reaction with an amine (typically Primene®81-R) to form an amine salt of a phosphate hydrocarbon ester.

When present in a lubricating composition, the composition may include at least 0.01 wt. %, or at least 0.1 wt. %, or at least 0.5 wt. % antiwear agent, and in some embodiments, up to 3 wt. %, or up to 1.5 wt. %, or up to 0.9 wt. antiwear agent.

### Antioxidants

Compositions prepared according to the instant disclosure may include at least one at least one antioxidant. Exemplary antioxidants useful herein include phenolic and aminic antioxidants, such as diarylamines, alkylated diarylamines, hindered phenols, and mixtures thereof. The diarylamine or alkylated diarylamine may be a phenyl-α-naphthylamine (PANA), an alkylated diphenylamine, an alkylated phenylnapthylamine, or mixture thereof. Example alkylated diphenylamines include dinonyl diphenylamine, nonyl diphenylamine, octyl diphenylamine, dioctyl diphenylamine, didecyl diphenylamine, decyl diphenylamine, and mixtures thereof. Example alkylated diarylamines include octyl, dioctyl, nonyl, dinonyl, decyl and didecyl phenylnapthylamines. Hindered phenol antioxidants often contain a secondary butyl and/or a tertiary butyl group as a steric hindering group. The phenol group may be further substituted with a hydrocarbyl group (e.g., a linear or branched alkyl) and/or a bridging group linking to a second aromatic group. Examples of suitable hindered phenol antioxidants include 2,6-di-tert-butylphenol, 4-methyl-2,6-di-tert-butylphenol, 4-ethyl-2,6-di-tert-butylphenol, 4-propyl-2,6-di-tert-butylphenol, 4-butyl-2,6-di-tert-butylphenol, and 4-dodecyl-2,6-di-tert-butylphenol. In one embodiment, the hindered phenol antioxidant may be an ester, such as those described in U.S. Pat. No. 6,559,105. One such hindered phenol ester is sold as Irganox™ L-135, obtainable from Ciba.

In one embodiment, a composition includes an amine antioxidant. The amine antioxidant may be a phenyl-α-naphthylamine (PANA) or a hydrocarbyl substituted diphenylamine, or mixtures thereof. The hydrocarbyl substituted diphenylamine may include mono- or di- C₄ to C₁₆-, or C₆ to C₁₂-, or C₉- alkyl diphenylamine. For example, the hydrocarbyl substituted diphenylamine may be octyl diphenylamine, or di-octyl diphenylamine, dinonyl diphenylamine, typically dinonyl diphenylamine.

The composition may, optionally, include at least one other antixodiant that is known and includes sulphurised olefins, hindered phenols, molybdenum dithiocarbamates, and mixtures thereof.

The hindered phenol antioxidant often contains a secondary butyl and/or a tertiary butyl group as a sterically hindering group. The phenol group is often further substituted with a hydrocarbyl group and/or a bridging group linking to a second aromatic group. Examples of suitable hindered phenol antioxidants include 2,6-di-tert-butylphenol, 4-methyl-2,6-di-tert-butylphenol, 4-ethyl-2,6-di-tert-butylphenol, 4-propyl-2,6-di-tert-butylphenol or 4-butyl-2,6-di-tert-butylphenol, or 4-dodecyl-2,6-di-tert-butylphenol. In one embodiment the hindered phenol antioxidant may be an ester and may include, e.g., Irganox™ L-135 from Ciba, or butyl 3-(3,5-di-tert-butyl-4-hydroxyphenyl)propanoate.

Antioxidants may include diarylamine, alkylated diarylamines, hindered phenols, molybdenum compounds (such as molybdenum dithiocarbamates), hydroxyl thioethers, trimethyl polyquinoline (e.g., 1,2-dihydro-2,2,4-trimethylquinoline), or mixtures thereof.

The diarylamine or alkylated diarylamine may be a phenyl-α-naphthylamine (PANA), an alkylated diphenylamine, or an alkylated phenylnaphthylamine, or mixtures thereof. The alkylated diphenylamine may include di-nonylated diphenylamine, nonyl diphenylamine, octyl diphenylamine, di-octylated diphenylamine, di-decylated diphenylamine, decyl diphenylamine, benzyl diphenylamine and mixtures thereof. In one embodiment the diphenylamine may include nonyl diphenyl amine, dinonyl diphenylamine, octyl diphenylamine, dioctyl diphenylamine, or mixtures thereof. In one embodiment the alkylated diphenylamine may include nonyl diphenylamine, or dinonyl diphenylamine. The alkylated diarylamine may include octyl, di-octyl, nonyl, di-nonyl, decyl or di-decyl phenylnaphthylamines. In one embodiment, the diphenylamine is alkylated with a benzene and t-butyl substituent.

The hindered phenol antioxidant often contains a secondary butyl and/or a tertiary butyl group as a sterically hindering group. The phenol group may be further substituted with a hydrocarbyl group (typically linear or branched alkyl) and/or a bridging group linking to a second aromatic group. Examples of suitable hindered phenol antioxidants include 2,6-di-tert-butylphenol, 4-methyl-2,6-di-tert-butylphenol, 4-ethyl-2,6-di-tert-butylphenol, 4-propyl-2,6-di-tert-butylphenol or 4-butyl-2,6-di-tert-butylphenol, or 4-dodecyl-2,6-di-tert-butylphenol. In one embodiment the hindered phenol antioxidant may be an ester and may include, e.g., Irganox™ L-135 from BASF GmbH. A more detailed description of suitable ester-containing hindered phenol anti-oxidant chemistry is found in U.S. Pat. No. 6,559,105.

Examples of molybdenum dithiocarbamates, which may be used as an antioxidants, include commercial materials sold under the trade names such as Molyvan 822®, Molyvan® A, Molyvan® 855 and from R. T. Vanderbilt Co., Ltd., and Adeka Sakura-Lube™ S100, S165, 5600 and 5525, or mixtures thereof. An example of an ashless dithiocarbamate which may be used as an anti-oxidant or anti-wear agent is Vanlube® 7723 from R. T. Vanderbilt Co., Ltd.

The antioxidant may include a substituted hydrocarbyl mono-sulfide represented by the formula:

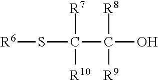

wherein R⁶ may be a saturated or unsaturated branched or linear alkyl group with 8 to 20 carbon atoms; R⁷, R⁸, R⁹ and R¹⁰ are independently hydrogen or alkyl containing 1 to 3 carbon atoms. In some embodiments the substituted hydrocarbyl monosulfides include n-dodecyl-2-hydroxyethyl sulfide, 1-(tert-dodecylthio)-2-propanol, or combinations thereof. In some embodiments the substituted hydrocarbyl monosulfide is 1-(tert-dodecylthio)-2-propanol.

The amount of antioxidant if it is present, may be 0.01 to 5 or 3 wt % of the lubricating composition.

When present in a lubricating composition, the composition may include at least 0.1 wt. % or at least 0.5 wt. %, or at least 1 wt. % antioxidant, and in some embodiments, up to 3 wt. %, or up to 2.75 wt. %, or up to 2.5 wt. % antioxidant.

When present, an amine antioxidant may be present in a composition, such as a driveline composition, at 0.2 wt % to 1.2 wt %, or 0.3 wt % to 1.0 wt %, or 0.4 wt % to 0.9 wt % or 0.5 wt % to 0.8 wt %, of the composition. If present, the secondary antioxidant may be present at 0.1 wt % to 1 wt %, or 0.2 wt % to 0.9 wt % or 0.1 wt % to 0.4 wt %, or 0.4 wt % to 1.0 wt %, of the composition.

The lubricant may include an antioxidant, or mixtures thereof. The antioxidant may be present in an industrial composition at 0 wt % to 4.0 wt %, or 0.02 wt % to 3.0 wt %, or 0.03 wt % to 1.5 wt % of the composition.

GREASE: The anti-oxidant may be present in a Grease additive at 0.001 wt % to 15 wt %, or 0.1 wt % to 10 wt %, or 0.5 wt % to 5 wt %, or 0.5 wt % to 3 wt %, or 0.3 wt % to 1.5 wt % of the grease composition.

FUELS: The fuel may include an antioxidant, or mixtures thereof. The antioxidant may be present in a fuel composition at is 0 to 200 ppm, or 0 to 100 ppm, or 0 to 50 ppm, or 5 to 200 ppm, or 10 to 150 ppm, or 10 to 100 ppm.

### Extreme Pressure Agent

A composition prepared according to the instant disclosure may include an extreme pressure agent. Example extreme pressure agents that are soluble in the oil include sulfur- and chlorosulfur-containing EP agents, dimercaptothiadiazole or CS₂ derivatives of dispersants (typically succinimide dispersants), derivative of chlorinated hydrocarbon EP agents and phosphorus EP agents. Examples of such EP agents include chlorinated wax; sulfurized olefins (such as sulfurized isobutylene), hydrocarbyl-substituted 2,5-dimercapto-1,3,4-thiadiazoles and oligomers thereof, organic sulfides and polysulfides, such as dibenzyldisulfide, bis-(chlorobenzyl) disulfide, dibutyl tetrasulfide, sulfurized methyl ester of oleic acid, sulfurized alkylphenol, sulfurized dipentene, sulfurized terpene, and sulfurized Diels-Alder adducts; phosphosulfurized hydrocarbons such as the reaction product of phosphorus sulfide with turpentine or methyl oleate; phosphorus esters, such as dihydrocarbon and trihydrocarbon phosphites, e.g., dibutyl phosphite, diheptyl phosphite, dicyclohexyl phosphite, pentylphenyl phosphite; dipentylphenyl phosphite, tridecyl phosphite, distearyl phosphite and polypropylene substituted phenol phosphite; metal thiocarbamates, such as zinc dioctyldithiocarbamate and barium heptylphenol diacid; amine salts of alkyl and dialkylphosphoric acids or derivatives including, for example, the amine salt of a reaction product of a dialkyldithiophosphoric acid with propylene oxide and subsequently followed by a further reaction with P₂O₅; and mixtures thereof. Some useful extreme pressure agents are described in U.S. Pat. No. 3,197,405.

When present, a lubricating composition may include at least 0.01 wt. %, or at least 0.1 wt. %, or at least 0.5 wt. % or at least 3 wt % extreme pressure agent, and in some embodiments, up to 6 wt. %, or up to 3 wt. %, or up to 1 wt. % of the extreme pressure agent.

GREASE: When present, the extreme pressure agent may be present at 0.001 wt % to 5 wt %, 0.01 wt % to 4 wt %, 0.01 wt % to 3.5 wt %, 0.05 wt % to 3 wt %, and 0.1 wt % to 1.5 wt %, or 0.2 wt % to 1 wt % of the grease composition.

DRIVELINE: The polysulfide extreme pressure agent typically provides about 0.5 to about 5 wt % or about 1 to about 3 wt % of Sulphur to the lubricating composition.

### Foam Inhibitors

A composition prepared according to the instant disclosure may include a foam inhibitor. Foam inhibitors that may be useful in the lubricant composition include polysiloxanes; copolymers of ethyl acrylate and 2-ethylhexylacrylate and optionally vinyl acetate; demulsifiers including fluorinated polysiloxanes, trialkyl phosphates, polyethylene glycols, polyethylene oxides, polypropylene oxides and (ethylene oxide-propylene oxide) polymers.

Anti-foam agents, also known as foam inhibitors, are known in the art and include organic silicones and non-silicon foam inhibitors. Examples of organic silicones include dimethyl silicone and polysiloxanes. Examples of non-silicon foam inhibitors include copolymers of ethyl acrylate and 2-ethylhexylacrylate, copolymers of ethyl acrylate, 2-ethylhexylacrylate and vinyl acetate, polyethers, polyacrylates and mixtures thereof. A particularly useful polyacrylate antifoam agent for fuels is the copolymer of tert-butyl acrylate and 3,3,5-trimethylhexyl acrylate and polymers of tert-butyl acrylate, 3,3,5-trimethylhexyl acrylate and poly(ethylene glycol) acrylate. In some embodiments the anti-foam is a polyacrylate. Another example of on non-silicone foam inhibitors include are polyacrylamides. In some embodiments, the polyacrylate can be a fluorinated polyacrylate.

ENGINE OILS: When the lubricating composition is for lubricating the crankcase of a spark ignited or compression ignited engine, the composition of the invention can include an antifoam component in an amount of 0.05 wt % to 2 wt % or 0.1 wt % to 1.2 wt % or 0.2 wt % to 0.75 wt %.

DRIVELINE: In some embodiments, the compositions of the invention are lubricating compositions for driveline devices which can include an antifoam component in an amount of at least 50 ppm, or at least 100ppm, or from 50ppm to 1000 ppm, or from about 50 to about 500, or from 50 ppm to 450 ppm or 400 ppm of the overall composition on an oil free basis

INDUSTRIAL: Antifoams may be present in the composition from 0.001 wt % to 0.012 wt % or 0.004 wt % or even 0.001 wt % to 0.003 wt %.

FUELS: Antifoams may be present in the fuel from 0.1 ppm to 3000 ppm, or 1 ppm to 100 ppm, or 75 ppm to 1500 ppm or even 500 ppm to 3000 ppm.

### Corrosion/Rust Inhibitors/Metal Deactivators

A composition prepared according to the instant disclosure may include a corrosion inhibitor. Corrosion inhibitors/metal deactivators that may be useful in the exemplary composition include fatty amines, octylamine octanoate, condensation products of dodecenyl succinic acid or anhydride, and a fatty acid such as oleic acid with a polyamine, derivatives of benzotriazoles (e.g., tolyltriazole), 1,2,4-triazoles, benzimidazoles, 2-alkyldithiobenzimidazoles and 2-alkyldithiobenzothiazoles.

The composition may also include a rust inhibitor. Suitable rust inhibitors include hydrocarbyl amine salts of alkylphosphoric acid, hydrocarbyl amine salts of dialkyldithiophosphoric acid, hydrocarbyl amine salts of hydrocarbyl aryl sulfonic acid, fatty carboxylic acids or esters thereof, an ester of a nitrogen-containing carboxylic acid, an ammonium sulfonate, an imidazoline, alkylated succinic acid derivatives reacted with alcohols or ethers, or any combination thereof; or mixtures thereof.

Suitable hydrocarbyl amine salts of alkylphosphoric acid may be represented by the following formula:

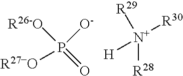

wherein R²⁶ and R²⁷ are independently hydrogen, alkyl chains or hydrocarbyl, typically at least one of R²⁶ and R²⁷ are hydrocarbyl. R²⁶ and R²⁷ contain 4 to 30, or 8 to 25, or 10 to 20, or 13 to 19 carbon atoms. R²⁸, R²⁹ and R³⁰ are independently hydrogen, alkyl branched or linear alkyl chains with 1 to 30, or 4 to 24, or 6 to 20, or 10 to 16 carbon atoms. R²⁸, R²⁹ and R³⁰ are independently hydrogen, alkyl branched or linear alkyl chains, or at least one, or two of R²⁸, R²⁹ and R³⁰ are hydrogen.

Examples of alkyl groups suitable for R²⁸, R²⁹ and R³⁰ include butyl, sec butyl, isobutyl, tert-butyl, pentyl, n-hexyl, sec hexyl, n-octyl, 2-ethyl, hexyl, decyl, undecyl, dodecyl, tridecyl, tetradecyl, pentadecyl, hexadecyl, heptadecyl, octadecyl, octadecenyl, nonadecyl, eicosyl or mixtures thereof.

In one embodiment, the hydrocarbyl amine salt of an alkylphosphoric acid is the reaction product of a C₁₄ to C₁₈ alkylated phosphoric acid with Primene® 81R (produced and sold by Rohm & Haas) which is a mixture of C₁₁ to C₁₄ tertiary alkyl primary amines.

Hydrocarbyl amine salts of dialkyldithiophosphoric acid may include a rust inhibitor such as a hydrocarbyl amine salt of dialkyldithiophosphoric acid. These may be a reaction product of heptyl or octyl or nonyl dithiophosphoric acids with ethylene diamine, morpholine or Primene® 81R or mixtures thereof.

The hydrocarbyl amine salts of hydrocarbyl aryl sulfonic acid may include ethylene diamine salt of dinonyl naphthalene sulfonic acid.

Examples of suitable fatty carboxylic acids or esters thereof include glycerol monooleate and oleic acid.

A composition may include a metal deactivator, or mixtures thereof. Metal deactivators may be chosen from derivatives of benzotriazole, 1,2,4-triazole, benzimidazole, 2-alkyldithiobenzimidazole, 2-alkyldithiobenzothiazole, or dimercaptothiadiazole. Examples of such derivatives include 2,5-dimercapto-1,3,4-thiadiazole, or oligomers thereof, a hydrocarbyl-substituted 2,5-dimercapto-1,3,4-thiadiazole, a hydrocarbylthio-substituted 2,5-dimercapto-1,3,4-thiadiazole, or oligomers thereof. The oligomers of hydrocarbyl-substituted 2,5-dimercapto-1,3,4-thiadiazole typically form by forming a sulfur-sulfur bond between 2,5-dimercapto-1,3,4-thiadiazole units to form oligomers of two or more of said thiadiazole units. Examples of a suitable thiadiazole compound include at least one of a dimercaptothiadiazole, 2,5-dimercapto-[1,3,4]-thiadiazole, 3,5-dimercapto-[1,2,4]-thiadiazole, 3,4-dimercapto-[1,2,5]-thiadiazole, or 4-5-dimercapto-[1,2,3]-thiadiazole. Typically, readily available materials such as 2,5-dimercapto-1,3,4-thiadiazole or a hydrocarbyl-substituted 2,5-dimercapto-1,3,4-thiadiazole or a hydrocarbylthio-substituted 2,5-dimercapto-1,3,4-thiadiazole are commonly utilized. In different embodiments the number of carbon atoms on the hydrocarbyl-substituent group includes 1 to 30, 2 to 25, 4 to 20, 6 to 16, or 8 to 10. The 2,5-dimercapto-1,3,4-thiadiazole may be 2,5-dioctyl dithio-1,3,4-thiadiazole, or 2,5-dinonyl dithio-1,3,4-thiadiazole. The metal deactivators may also be described as corrosion inhibitors.

ENGINE OILS: The rust inhibitors may be present in a lubricating composition in the range from 0 to 2 wt % or 0.05 wt % to 2 wt %, from 0.1 wt % to 1.0 wt %, from 0.2 wt % to 0.5 wt %, of the lubricating oil composition. The rust inhibitors may be used alone or in mixtures thereof.

INDUSTRIAL: The rust inhibitors may be present in an industrial composition in the range from 0 or 0.02 wt % to 0.2 wt %, from 0.03 wt % to 0.15 wt %, from 0.04 wt % to 0.12 wt %, or from 0.05 wt % to 0.1 wt % of the lubricating oil composition. The rust inhibitors may be used alone or in mixtures thereof.

The metal deactivators may be present in the range from 0 or 0.001 wt % to 0.1 wt %, from 0.01 wt % to 0.04 wt % or from 0.015 wt % to 0.03 wt % of the lubricating oil composition. Metal deactivators may also be present in the composition from 0.002 wt % or 0.004 wt % to 0.02 wt %. The metal deactivator may be used alone or mixtures thereof.

GREASE: The metal deactivator may be present in the lubricating grease composition at a concentration in the range up to 5 wt %, or 0.0002 to 2 wt %, or 0.001 to 1 wt %.

The rust inhibitors may present in the lubricating grease composition at a concentration in the range up to 4 wt %, and in one embodiment in the range from 0.02 wt % to 2 wt %, and in one embodiment in the range from 0.05 wt % to 1 wt %

### Pour Point Depressants

A composition prepared according to the instant disclosure may include a pour point depressant. Pour point depressants that may be useful in the exemplary lubricating composition include polyalphaolefins, esters of maleic anhydride-styrene copolymers, polymethacrylates, polyacrylates, and polyacrylamides.

Pour point depressants are known in the art and include esters of maleic anhydride-styrene copolymers, polymethacrylates; polyacrylates; polyacrylamides; condensation products of haloparaffin waxes and aromatic compounds; vinyl carboxylate polymers; and terpolymers of dialkyl fumarates, vinyl esters of fatty acids, ethylene-vinyl acetate copolymers, alkyl phenol formaldehyde condensation resins, alkyl vinyl ethers and mixtures thereof.

The Pour point depressants may be present in a lubricating composition in the range from 0.01 wt % to 2 wt % or 0.05 wt % to 1 wt % or 0.1wt % to 0.6 wt % of the lubricating oil composition. The Pour point depressants may be used alone or in mixtures thereof.

### Friction Modifiers

A composition prepared according to the instant disclosure may include a friction modifier. Friction modifiers that may be useful in the exemplary composition include fatty acid derivatives such as amines, esters, epoxides, fatty imidazolines, condensation products of carboxylic acids and polyalkylene-polyamines and amine salts of alkylphosphoric acids. The friction modifier may be an ash-free friction modifier. Such friction modifiers are those which typically not produce any sulfated ash when subjected to the conditions of ASTM D 874. An additive is referred to as “non-metal containing” if it does not contribute metal content to the lubricant composition. As used herein the term “fatty alkyl” or “fatty” in relation to friction modifiers means a carbon chain having 8 to 30 carbon atoms, typically a straight carbon chain.

In one embodiment, the ash-free friction modifier may be represented by the formula:

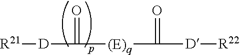

where, D and D′ are independently selected from —O—, >NH, >NR²³, an imide group formed by taking together both D and D′ groups and forming a R²¹—N< group between two >C═O groups; E is selected from -R²⁴—O—R²⁵—, >CH₂, >CHR²⁶, >CR²⁶R²⁷, >C(OH)(CO₂R²²), >C(CO₂R²²)₂, and >CHOR²⁸; where R²⁴ and R²⁵ are independently selected from >CH₂, >CHR²⁶, >CR²⁶R²⁷, >C(OH)(CO₂R²²), and >CHOR²⁸; q is 0 to 10, with the proviso that when q=1, E is not >CH₂, and when n=2, both Es are not >CH₂; p is 0 or 1; R²¹ is independently hydrogen or a hydrocarbyl group, typically containing 1 to 150 carbon atoms, with the proviso that when R²¹ is hydrogen, p is 0, and q is more than or equal to 1; R²² is a hydrocarbyl group, typically containing 1 to 150 carbon atoms; R²³, R²⁴, R²⁵, R²⁶ and R²⁷ are independently hydrocarbyl groups; and R²⁸ is hydrogen or a hydrocarbyl group, typically containing 1 to 150 carbon atoms, or 4 to 32 carbon atoms, or 8 to 24 carbon atoms. In certain embodiments, the hydrocarbyl groups R²³, R²⁴, and R²⁵, may be linear or predominantly linear alkyl groups.

In certain embodiments, the ash-free friction modifier is a fatty ester, amide, or imide of various hydroxy-carboxylic acids, such as tartaric acid, malic acid lactic acid, glycolic acid, and mandelic acid. Examples of suitable materials include tartaric acid di(2-ethylhexyl) ester (i.e., di(2-ethylhexyl)tartrate), di(C₈-C₁₀)tartrate, di(C₁₂₋₁₅)tartrate, di-oleyltartrate, oleyltartrimide, and oleyl maleimide.

In certain embodiments, the ash-free friction modifier may be chosen from long chain fatty acid derivatives of amines, fatty esters, or fatty epoxides; fatty imidazolines such as condensation products of carboxylic acids and polyalkylene-polyamines; amine salts of alkylphosphoric acids; fatty alkyl tartrates; fatty alkyl tartrimides; fatty alkyl tartramides; fatty phosphonates; fatty phosphites; borated phospholipids, borated fatty epoxides; glycerol esters; borated glycerol esters; fatty amines; alkoxylated fatty amines; borated alkoxylated fatty amines; hydroxyl and polyhydroxy fatty amines including tertiary hydroxy fatty amines; hydroxy alkyl amides; metal salts of fatty acids; metal salts of alkyl salicylates; fatty oxazolines; fatty ethoxylated alcohols; condensation products of carboxylic acids and polyalkylene polyamines; or reaction products from fatty carboxylic acids with guanidine, aminoguanidine, urea, or thiourea and salts thereof.

Friction modifiers may also encompass materials such as sulfurized fatty compounds and olefins, sunflower oil or soybean oil monoester of a polyol and an aliphatic carboxylic acid.

In another embodiment, the friction modifier may be a long chain fatty acid ester. In another embodiment the long chain fatty acid ester may be a mono-ester and in another embodiment the long chain fatty acid ester may be a triglyceride.

Molybdenum compounds are also known as friction modifiers. The exemplary molybdenum compound does not contain dithiocarbamate moieties or ligands.

Nitrogen-containing molybdenum materials include molybdenum-amine compounds, as described in U.S. Pat. No. 6,329,327, and organomolybdenum compounds made from the reaction of a molybdenum source, fatty oil, and a diamine as described in U.S. Pat. No. 6,914,037. Other molybdenum compounds are disclosed in U.S. Pub. No. 20080280795. Molybdenum amine compounds may be obtained by reacting a compound containing a hexavalent molybdenum atom with a primary, secondary or tertiary amine represented by the formula NR²⁹R³⁰R³¹, where each of R²⁹, R³⁰ and R³¹ is independently hydrogen or a hydrocarbyl group of 1 to 32 carbon atoms and wherein at least one of R²⁹, R³⁰ and R³¹ is a hydrocarbyl group of 4 or more carbon atoms or represented by the formula:

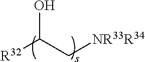

where R³² represents a chain hydrocarbyl group having 10 or more carbon atoms, s is 0 or 1, R³³ and/or R³⁴ represents a hydrogen atom, a hydrocarbyl group, an alkanol group or an alkyl amino group having 2 to 4 carbon atoms, and when s=0, both R³³ and R³⁴ are not hydrogen atoms or hydrocarbon groups.

Specific examples of suitable amines include monoalkyl (or alkenyl) amines such as tetradecylamine, stearylamine, oleylamine, beef tallow alkylamine, hardened beef tallow alkylamine, and soybean oil alkylamine; dialkyl(or alkenyl)amines such as N-tetradecylmethylamine, N-pentadecylmethylamine, N-hexadecylmethylamine, N-stearylmethylamine, N-oleylmethylamine, N-dococylmethylamine, N-beef tallow alkyl methylamine, N-hardened beef tallow alkyl methylamine, N-soybean oil alkyl methylamine, ditetradecylamine, dipentadecylamine, dihexadecyl amine, distearylamine, dioleylamine, didococylamine, bis(2-hexyldecyl)amine, bis(2-octyldodecyl)amine, bis(2-decyltetradecyl)amine, beef tallow dialkylamine, hardened beef tallow dialkylamine, and soybean oil dialkylamine; and trialk(en)ylamines such as tetradecyldimethylamine, hexadecyldimethylamine, octadecyldimethylamine, beef tallow alkyldimethylamine, hardened beef tallow alkyldimethylamine, soybean oil alkyl dimethylamine, dioleylmethylamine, tritetradecylamine, tristearylamine, and trioleylamine. Suitable secondary amines have two alkyl (or alkenyl) groups with 14 to 18 carbon atoms.

Examples of the compound containing the hexavalent molybdenum atom include molybdenum trioxides or hydrates thereof (MoO₃·nH₂O), molybdenum acid (H₂MoO₄), alkali metal molybdates (Q₂MoO₄) wherein Q represents an alkali metal such as sodium and potassium, ammonium molybdates {(NH₄)₂MoO₄ or heptamolybdate (NH₄)₆[Mo₇O₂₄]·4H₂O}, MoOCl₄, MoO₂Cl₂, MoO₂Br₂, Mo₂O₃Cl₆ and the like. Molybdenum trioxides or hydrates thereof, molybdenum acid, alkali metal molybdates and ammonium molybdates are often suitable because of their availability. In one embodiment, the lubricating composition comprises molybdenum amine compound.

Other organomolybdenum compounds of the invention may be the reaction products of fatty oils, mono-alkylated alkylene diamines and a molybdenum source. Materials of this sort are generally made in two steps, a first step involving the preparation of an aminoamide/glyceride mixture at high temperature, and a second step involving incorporation of the molybdenum.

Examples of fatty oils that may be used include cottonseed oil, groundnut oil, coconut oil, linseed oil, palm kernel oil, olive oil, corn oil, palm oil, castor oil, rapeseed oil (low or high erucic acids), soyabean oil, sunflower oil, herring oil, sardine oil, and tallow. These fatty oils are generally known as glyceryl esters of fatty acids, triacylglycerols or triglycerides.

Examples of some mono-alkylated alkylene diamines that may be used include methylaminopropylamine, methylaminoethylamine, butylaminopropylamine, butylamino-ethylamine, octylaminopropylamine, octylaminoethylamine, dodecylaaminopropylaamine, dodecylaminoethylamine, hexadecylaminopropylamine, hexadecylaminoethylamine, octadecyl-aminopropylamine, octadecylaminoethylamine, isopropyloxypropyl-1,3 -diaminopropane, and octyloxypropyl-1,3 aminopropane. Mono-alkylated alkylene diamines derived from fatty acids may also be used. Examples include N-coco alkyl-1,3-propanediamine (Duomeen®C), N-tall oil alkyl-1,3-propanediamine (Duomeen®T) and N-oleyl-1,3-propanediamine (Duomeen®O), all commercially available from Akzo Nobel.

Sources of molybdenum for incorporation into the fatty oil/diamine complex are generally oxygen-containing molybdenum compounds include, similar to those above, ammonium molybdates, sodium molybdate, molybdenum oxides and mixtures thereof. One suitable molybdenum source comprises molybdenum trioxide (MoO₃).

Nitrogen-containing molybdenum compounds which are commercially available include, for example, Sakuralube® 710 available from Adeka which is a molybdenum amine compound, and Molyvan® 855, available from R. T. Vanderbilt.

In one embodiment, the friction modifier may be formed by the condensation of the hydroxyalkyl compound with an acylating agent or an amine. A more detailed description of the hydroxyalkyl compound is described in U.S. patent application Ser. No. 60/725360 (filed on Oct. 11, 2005, inventors Bartley, Lahiri, Baker and Tipton) in paragraphs 8, 19-21. The friction modifier disclosed in U.S. patent application Ser. No. 60/725360 may be an amide represented by the formula R¹R²N—C(O)R³, wherein R¹ and R² are each independently hydrocarbyl groups of at least 6 carbon atoms and R³ is a hydroxyalkyl group of 1 to 6 carbon atoms or a group formed by the condensation of said hydroxyalkyl group, through a hydroxyl group thereof, with an acylating agent. Preparative Examples are disclosed in Examples 1 and 2 (paragraphs 68 and 69). In one embodiment the amide of a hydroxylalkyl compound is prepared by reacting glycolic acid, that is, hydroxyacetic acid, HO—CH₂—COOH with an amine.

In one embodiment, the friction modifier may be a secondary or tertiary amine being represented by the formula R⁴R⁵NR⁶, wherein R⁴ and R⁵ are each independently an alkyl group of at least 6 carbon atoms and R⁶ is hydrogen, a hydrocarbyl group, a hydroxyl-containing alkyl group, or an amine-containing alkyl group. A more detailed description of the friction modifier is described in U.S. patent application Ser. No. 05/037897 in paragraphs 8 and 19 to 22.

In one embodiment, the friction modifier may be derived from the reaction of a carboxylic acid or a reactive equivalent thereof with an aminoalcohol, wherein the friction modifier contains at least two hydrocarbyl groups, each containing at least 6 carbon atoms. An example of such a friction modifier includes the reaction product of isostearic acid or an alkyl succinic anhydride with tris-hydroxymethylaminomethane. A more detailed description of such a friction modifier is disclosed in International Publication WO04/007652) in paragraphs 8 and 9 to 14.

The friction modifier includes fatty amines, borated glycerol esters, fatty acid amides, non-borated fatty epoxides, borated fatty epoxides, alkoxylated fatty amines, borated alkoxylated fatty amines, metal salts of fatty acids, fatty imidazolines, metal salts of alkyl salicylates (may also be referred to as a detergent), metal salts of sulphonates (may also be referred to as a detergent), condensation products of carboxylic acids or polyalkylene-polyamines, or amides of hydroxyalkyl compounds.

In one embodiment, the friction modifier includes a fatty acid ester of glycerol. The final product may be in the form of a metal salt, an amide, an imidazoline, or mixtures thereof. The fatty acids may contain 6 to 24, or 8 to 18 carbon atoms. The fatty acids may branched or straight-chain, saturated or unsaturated. Suitable acids include 2-ethylhexanoic, decanoic, oleic, stearic, isostearic, palmitic, myristic, palmitoleic, linoleic, lauric, and linolenic acids, and the acids from the natural products tallow, palm oil, olive oil, peanut oil, corn oil, and Neat's foot oil. In one embodiment the fatty acid is oleic acid. When in the form of a metal salt, typically the metal includes zinc or calcium; and the products include overbased and non-overbased products. Examples are overbased calcium salts and basic oleic acid-zinc salt complexes which may be represented by the general formula Zn₄Oleate₆O. When in the form of an amide, the condensation product includes those prepared with ammonia, or with primary or secondary amines such as diethylamine and diethanolamine. When in the form of an imidazoline, the condensation product of an acid with a diamine or polyamine such as a polyethylenepolyamine. In one embodiment, the friction modifier is the condensation product of a fatty acid with C8 to C24 atoms, and a polyalkylene polyamine, and in particular, the product of isostearic acid with tetraethylenepentamine.

In one embodiment, the friction modifier includes those formed by the condensation of the hydroxyalkyl compound with an acylating agent or an amine. A more detailed description of the hydroxyalkyl compound is described in WO 2007/0044820 paragraphs 9, and 20-22. The friction modifier disclosed in WO2007/044820 includes an amide represented by the formula R¹²R¹³N—C(O)R¹⁴, wherein R¹² and R¹³ are each independently hydrocarbyl groups of at least 6 carbon atoms and R¹⁴ is a hydroxyalkyl group of 1 to 6 carbon atoms or a group formed by the condensation of said hydroxyalkyl group, through a hydroxyl group thereof, with an acylating agent. Preparative Examples are disclosed in Examples 1 and 2 (paragraphs 72 and 73 of WO2007/044820). In one embodiment the amide of a hydroxylalkyl compound is prepared by reacting glycolic acid, that is, hydroxyacetic acid, HO—CH₂—COOH with an amine.

In one embodiment, the friction modifier includes a reaction product of a di-cocoalkyl amine (or di-cocoamine) with glycolic acid. The friction modifier includes compounds prepared in Preparative Examples 1 and 2 of WO 2008/014319.

In one embodiment, the friction modifier includes an alkoxylated alcohol. A detailed description of suitable alkoxylated alcohols is described in paragraphs 19 and 20 of US Patent Application 2005/0101497. The alkoxylated amines are also described in U.S. Pat. No. 5,641,732 in column 7, line 15 to column 9, line 25.

In one embodiment the friction modifier includes a hydroxyl amine compound as defined in column 37, line 19, to column 39, line 38 of U.S. Pat. No. 5,534,170. Optionally the hydroxyl amine includes borated as such products are described in column 39, line 39 to column 40 line 8 of U.S. Pat. No. 5,534,170.

In one embodiment, the friction modifier includes an alkoxylated amine e.g., an ethoxylated amine derived from 1.8% Ethomeen™ T-12 and 0.90% Tomah™ PA-1 as described in Example E of U.S. Pat. No. 5,703,023, column 28, lines 30 to 46. Other suitable alkoxylated amine compounds include commercial alkoxylated fatty amines known by the trademark “ETHOMEEN” and available from Akzo Nobel. Representative examples of these ETHOMEEN™ materials is ETHOMEEN™ C/12 (bis[2-hydroxyethyl]-coco-amine); ETHOMEEN™ C/20 (polyoxyethylene[10]cocoamine); ETHOMEEN™ S/12 (bis[2-hydroxyethyl]soyamine); ETHOMEEN™ T/12 (bis[2-hydroxyethyl]-tallow-amine); ETHOMEEN™ T/15 (polyoxyethylene-[5]tallowamine); ETHOMEEN™ 0/12 (bis[2-hydroxyethyl]oleyl-amine); ETHOMEEN™ 18/12 (bis[2-hydroxyethyl]octadecylamine); and ETHOMEEN™ 18/25 (polyoxyethylene[15]-octadecylamine). Fatty amines and ethoxylated fatty amines are also described in U.S. Pat. No. 4,741,848.

In one embodiment, the friction modifier includes a polyol ester as described in U.S. Pat. No. 5,750,476 column 8, line 40 to column 9, line 28.

In one embodiment the friction modifier includes a low potency friction modifier as described in U.S. Pat. No. 5,840,662 in column 2, line 28 to column 3, line 26. U.S. Pat. No. 5,840,662 further discloses in column 3, line 48 to column 6, line 25 specific materials and methods of preparing the low potency friction modifier.

In one embodiment, the friction modifier includes a reaction product of an isomerised alkenyl substituted succinic anhydride and a polyamine as described in U.S. Pat. No. 5,840,663 in column 2, lines 18 to 43. Specific embodiments of the friction modifier described in U.S. Pat. No. 5,840,663 are further disclosed in column 3, line 23 to column 4, line 35. Preparative examples are further disclosed in column 4, line 45 to column 5, line 37 of U.S. Pat. No. 5,840,663.

In one embodiment, the friction modifier includes an alkylphosphonate mono- or di- ester sold commercially by Rhodia under the trademark Duraphos® DMODP.

The condensation of a fatty acid and a polyamine typically result in the formation of at least one compound chosen from hydrocarbyl amides, hydrocarbyl imidazolines and mixtures thereof. In one embodiment the condensation products are hydrocarbyl imidazolines. In one embodiment the condensation products are hydrocarbyl amides. In one embodiment the condensation products are mixtures of hydrocarbyl imidazolines and hydrocarbyl amides. Typically, the condensation product is a mixture of hydrocarbyl imidazolines and hydrocarbyl amides.

The fatty acid may be derived from a hydrocarbyl carboxylic acid. The hydrocarbyl group may be alkyl, cycloalkyl, or aryl, although alkyl is typical, and the hydrocarbyl groups may be linear or branched. Typically, the fatty acid contains 8 or more, 10 or more, more 13 or 14 or more carbon atoms (including the carbon of the carboxy group). Typically, the fatty acid contains 8 to 30, 12 to 24, or 16 to 18 carbon atoms. Other suitable carboxylic acids may include the polycarboxylic acids or carboxylic acids or anhydrides having from 2 to 4 carbonyl groups, typically 2. The polycarboxylic acids may include succinic acids and anhydrides and Diels-Alder reaction products of unsaturated monocarboxylic acids with unsaturated carboxylic acids (such as acrylic, methacrylic, maleic, fumaric, crotonic and itaconic acids). The fatty carboxylic acids include fatty monocarboxylic acids containing 8 to 30, 10 to 26, or 12 to 24 carbon atoms.

Examples of suitable fatty acids may include caprylic acid, capric acid, lauric acid, myristic acid, palmitic acid, stearic acid, eicosic acid and, tall oil acids. In one embodiment the fatty acid is stearic acid, which may be used alone or in combination with other fatty acids.

One or both friction modifiers may in one embodiment be nitrogen-containing compounds, typically both friction modifiers are nitrogen-containing.

In one embodiment, one of friction modifiers is the condensation product of a fatty acid with C8 to C24 atoms, and a polyalkylene polyamine, and in particular, the product of isostearic acid with tetraethylenepentamine.

As used herein, the term “fatty alkyl” or “fatty” in relation to friction modifiers means a carbon chain having 8 to 22 carbon atoms, typically a straight carbon chain. Alternatively, the fatty alkyl may be a mono branched alkyl group, with branching typically at the β-position. Examples of mono branched alkyl groups include 2-ethylhexyl, 2-propylheptyl or 2-octyldodecyl.

Examples of suitable friction modifiers include long chain fatty acid derivatives of amines, fatty esters, or fatty epoxides; fatty imidazolines such as condensation products of carboxylic acids and polyalkylene-polyamines; amine salts of alkylphosphoric acids; fatty phosphonates; fatty phosphites; borated phospholipids, borated fatty epoxides; glycerol esters; borated glycerol esters; fatty amines; alkoxylated fatty amines; borated alkoxylated fatty amines; hydroxyl and polyhydroxy fatty amines; hydroxy alkyl amides; metal salts of fatty acids; metal salts of alkyl salicylates; fatty oxazolines; fatty ethoxylated alcohols; condensation products of carboxylic acids and polyalkylene polyamines; or reaction products from fatty carboxylic acids with guanidine, aminoguanidine, urea, or thiourea and salts thereof.

The amount of the ash-free friction modifier in a lubricant may be 0.1 to 3 percent by weight (or 0.12 to 1.2 or 0.15 to 0.8 percent by weight). The material may also be present in a concentrate, alone or with other additives and with a lesser amount of oil. In a concentrate, the amount of material may be two to ten times the above concentration amounts.

The nitrogen-containing molybdenum compound may be present in the lubricant composition at 0.005 to 2 wt. % of the composition, or 0.01 to 1.3 wt. %, or 0.02 to 1.0 wt. % of the composition. The molybdenum compound may provide the lubricant composition with 0 to 1000 ppm, or 5 to 1000 ppm, or 10 to 750 ppm 5 ppm to 300 ppm, or 20 ppm to 250 ppm of molybdenum.

The lubricant composition may include a friction modifier, typically at least two friction modifiers. Useful friction modifiers are described below. In one embodiment, a friction modifier is typically present at 0 to 4 wt %, or 0.1 to 4 wt %, 0.2 to 3 wt %, 0.3 to 3 wt %, 0.25 to 2.5 wt %. In one embodiment, the friction modifier is present, and in an alternative embodiment the friction modifier is not present.

GREASE: In one embodiment, the lubricating grease disclosed herein may contain at least one friction modifier. The friction modifier may be present at 0 wt % to 6 wt %, or 0.01 wt % to 4 wt %, or 0.05 wt % to 2 wt %, or 0.1 wt % to 2 wt % of the grease composition

FUELS: Friction modifiers may be present in the fuel from 0.1 ppm to 3000 ppm, or 10 ppm to 1000 ppm or 15 ppm to 500 ppm, or 25 ppm to 300 ppm or even 50 ppm to 300 ppm.

### Demulsifiers

A composition prepared according to the instant disclosure may include a demulsifier. Demulsifiers useful herein include trialkyl phosphates, and various polymers and copolymers of ethylene glycol, ethylene oxide, propylene oxide, and mixtures thereof.

Demulsifiers are known in the art and include derivatives of propylene oxide, ethylene oxide, polyoxyalkylene alcohols, alkyl amines, amino alcohols, diamines or polyamines reacted sequentially with ethylene oxide or substituted ethylene oxides or mixtures thereof. Examples of demulsifiers include polyethylene glycols, polyethylene oxides, polypropylene oxides, (ethylene oxide-propylene oxide) polymers and mixtures thereof. In some embodiments, the demulsifiers is a polyether. In one embodiment, the demulsifier may be an oxyalkylated phenolic resin blend. Such a blend may comprise formaldehyde polymers with 4-nonylphenol, ethylene oxide and propylene oxide and formaldehyde polymers with 4-nonylphenol ethylene oxide. Demulsifiers may be present in the composition from 0.002 wt % to 0.012 wt %.

### Seal Swell Agents

Seal swell agents may also be included in a composition prepared according to the instant disclosure. Useful seal swell agents include sulfolene derivatives such as Exxon Necton-37™ (FN 1380) and Exxon Mineral Seal Oil™ (FN 3200).

Another useful seal swell agent is substituted sulfonyldibenzene compounds of formula

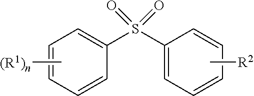

wherein: n is 0 or 1 ;
R¹ and R² are each independently a group represented by R³ or R⁴ _{P}-Y;
R³ is a hydrocarbyl group of about 4 or about 12 to about 20, about 6 to about 18, about 6 to about 14 or about 6 to about 8 carbon atoms;
R⁴ is an alkylene group of about 1 or 2 carbon atoms; p is 0 or 1 ;
—Y is -Z—R⁵ where -Z- is chosen from —H—, —N(R⁶)—where R⁶ is a hydrocarbyl group of about from 6 to about 18 carbon atoms, —N═CH— —HC═N— —O—C(O)—, and —C(0)-0 and
R⁵ is hydrogen or an aliphatic hydrocarbyl group of about 4 or about 12 to about 20, about 6 to about 18, about 6 to about 14 or about 6 to about 8 carbon atoms; or —Y is represented by formula

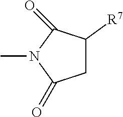

where R⁷ is a hydrocarbyl group containing from about 8 to about 100, about 12 to about 24, about 8 to about 16, about 14 to about 16 or about 40 to about 70 carbon atoms.

In one embodiment, the lubricant composition is a hydraulics oil, a turbine oil, or a Circulating Oil and contains the seal swell agent in an amount from 0.01 wt % or 0.05 wt % to 2 wt %, or 0.01 wt % or 0.05 wt % to 1.5 wt %, or 0.05 wt % to 1 wt %, or 0.1 wt % to 1 wt %, or 0.15 wt % to 0.5 wt % of the overall composition.

GREASE: The grease composition or the lubricating grease composition may comprise 0.01 or 0.05 to 2 wt %, or 0.01 or 0.05 to 1.5 wt %, 0.05 to 1 wt %, 0.15 to 1 wt %, 0.15 to 0.5 wt % of the seal swell agent The additive package may be present at 0.01 wt % to 10 wt %, or 0.01 wt % to 5 wt %, or 0.1 to 3 wt % of the grease composition.

### Acoustic Mixing

Compositions disclosed herein can be prepared by mixing one or more of the components using an acoustic mixer. Acoustic mixing imparts acoustic energy onto one or more materials to mix, react, coat, or combine the materials. Solid as well as liquid materials can be processed. Highly viscous materials as well as thinner materials can be processed via an acoustic mixer. Suitable acoustic mixer for use in preparing the compositions of the instant disclosure are described in U.S. Pat. No. 10,130,924; U.S. Patent Application Publication No. US 2019/0070574; U.S. Patent Application Publication No. 2019/0060853; and U.S. Patent Application Publication No. 2013/0329514 all in the name of Resodyn Corporation and all incorporated herein by reference in their entireties.

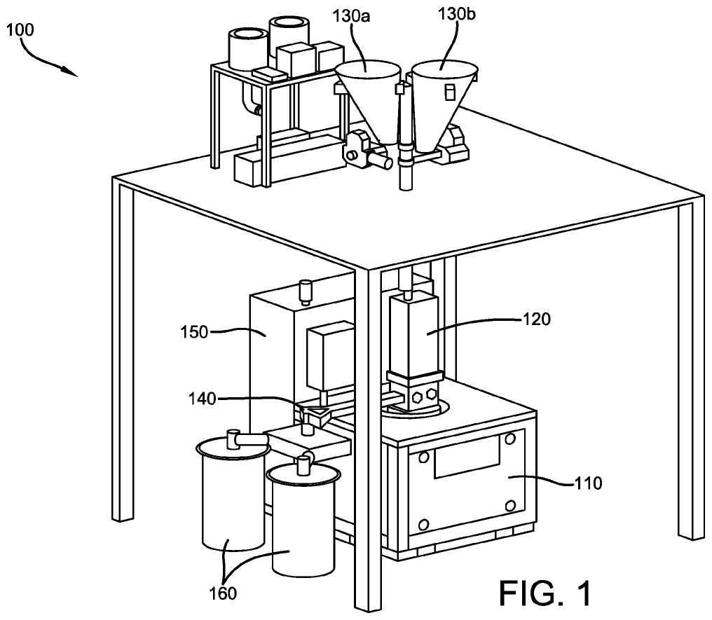

FIG. 1 illustrates an embodiment of a continuous acoustic mixer (“CAM”) 100 suitable for use in preparing compositions according to the instant disclosure. This CAM is described in one or more of the Resodyn references cited above. The CAM 100 includes a continuous process vessel 120 coupled to an acoustic agitator 110. The acoustic agitator 110 receives power from an electrical cabinet 150. The continuous process vessel 120 can include a first inlet 130a configured for receiving at least a first process ingredient and a second inlet 130b configured for receiving at least a second process ingredient. The process ingredients can be additives as described herein, an oil of lubricating viscosity, a fuel, or any combination thereof. The continuous process vessel 120 includes an outlet 140 for discharging a product of the process ingredients subsequent to the process ingredients passing through a portion of the continuous process vessel 120 while being exposed to the acoustic energy. The outlet 140 can discharge the product into, for example, one or more drums 160. A support frame 170 can hold various components of the CAM 100.

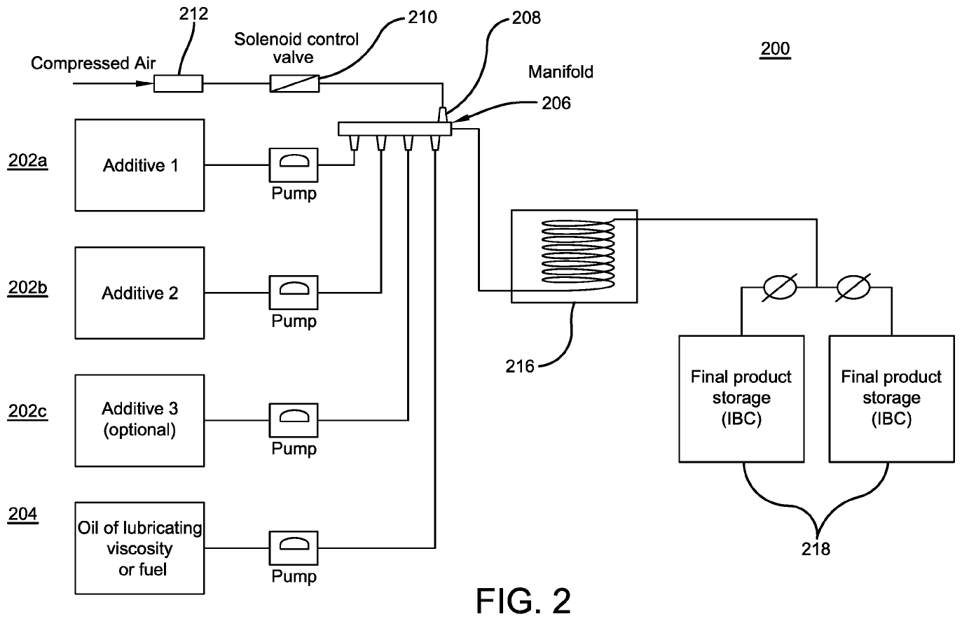

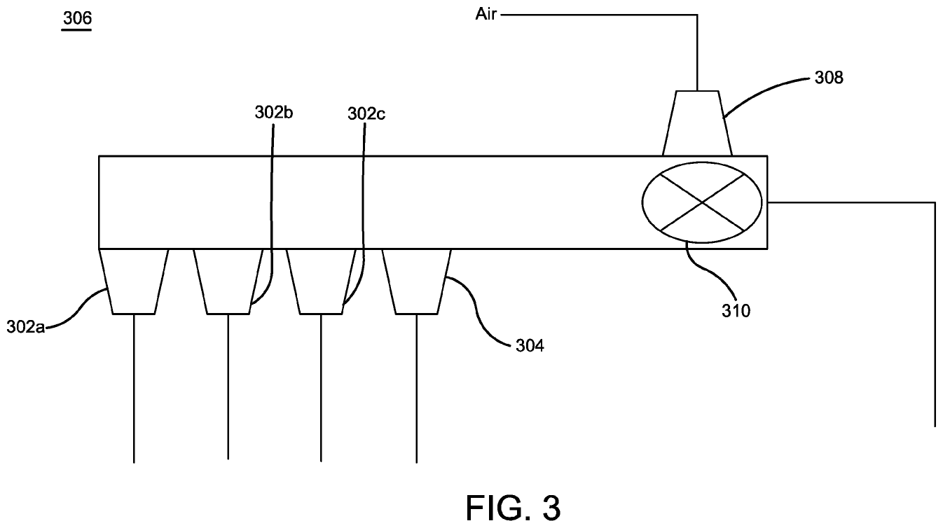

FIG. 2 illustrates an exemplary schematic of an embodiment of a CAM 200. In CAM 200, additives 202a, 202b, and 202c and an oil of lubricating viscosity or fuel 204 can be pumped to a manifold 206. The manifold 206 is configured to accept the additive 202a, 202b, and 202c via their respective conduits. The manifold 206 can include a pre-mixer (shown in FIG. 3) to mix the additives 202a, 202b, and 202c either the oil of lubricating viscosity or fuel 204 and optionally air. The manifold 206 can regulate the amount of each of the additives 202a, 202b, and 202c and/or oil of lubricating viscosity or fuel 204 to obtain a proper lubricant or fuel mixture. In addition, the manifold 206 further includes an air inlet 208 the is in operable communication with a solenoid valve control 210 and a source of compressed air 212. The manifold 206 can therefore mix air with the additives/lubricant or fuel mixture prior to acoustic mixing.

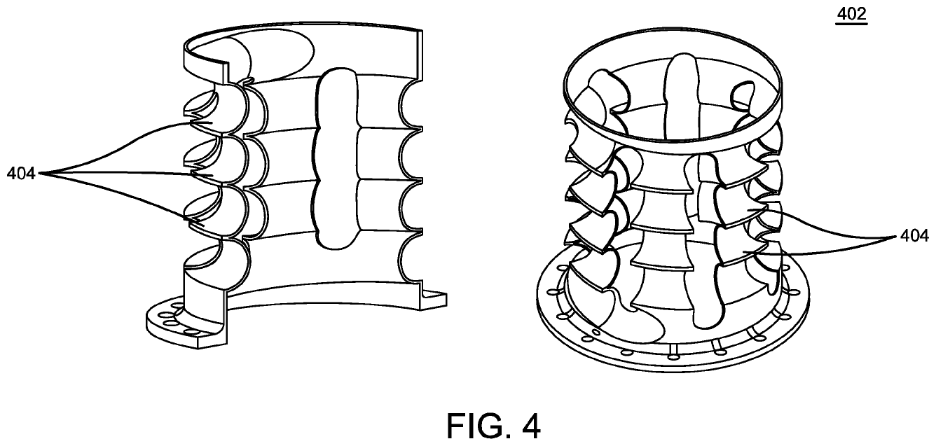

The lubricant or fuel mixture 204 including additives 202a, 202b, and 202c, and optionally air, traverses a conduit 214 to the acoustic mixer 216. The acoustic mixer 216 includes a mandrel 402 (shown in FIG. 4) that accepts the conduit 216. The conduit 216 serpentines arounds a central line of the mandrel 402 and is affixed to the mandrel 402 in a manner that the additives/lubricant or fuel mixture conduit 214 is received at the mandrel 402 at the bottom serpentining around the mandrel 402 in a bottom-to-top configuration. The additives/lubricant or fuel mixture are mixed in the conduit 214 wrapped around the mandrel 402 in a continuous manner such that as the additives/lubricant or fuel mixture travels through the conduit 214 it is mixed in the acoustic mixer 216 resulting in a continuous flow mixing. After mixing, the additives/lubricant or fuel mixture exit the acoustic mixer 216 and are transported to a final product storage 218.

In an embodiment of operation, the components or additives 202a, 202b, and 202c travel up the conduit 216 in the acoustic mixer 200, exiting the top of the acoustic mixer 200 as a fully mixed product. Pumps draw the additives 202a, 202b, and 202c oil of lubricating viscosity or fuel 204 to the manifold 206 where, optionally, at pulse of air from the air inlet 208 can be introduced into the mixture.

FIG. 3 illustrates an exemplary embodiment of a manifold 306 suitable for use in the mixing process. The manifold 306 includes inlets for additives 302a, 302b, and 302c and an inlet 304 for an oil of lubricating viscosity or fuel. The additives 302a, 302b, and 302c can be any additives disclosed herein or other additives that would be apparent to one of ordinary skill in the art. The manifold 306 is configured to accept or manipulate the feed rates of the additives 302a, 302b, and 302c and/or the oil of lubricating viscosity or fuel (inlet 304) to arrive at a specific ratio of ingredients needed for either a lubricant or fuel mixture. The manifold 306 further includes an air inlet 308 that can optionally provide air for mixing with the additive 302a, 302b, and 302c and/or oil of lubricating viscosity or fuel. The manifold further includes a premixer 310 that can premix the lubricant or fuel mixture prior to acoustic mixing. In some embodiments, the premixer 310 can be a venturi mixer. Once the additives 302a, 302b, and 302c, oil of lubricating viscosity or fuel, and, optionally, air are combined in the manifold 306 they can be transported for acoustic mixing via conduit 314.

FIG. 4 illustrates an exemplary embodiment of a mandrel 402 suitable for use in the acoustic mixer described in this disclosure. The mandrel 402 includes a plurality of flanges 404 forming a cup-shaped depression serpentining around the mandrel 402 and configured to accept a conduit (not shown). In another embodiment, the conduit can be formed as part of the mandrel where, for example, a tube-like formation can be 3D printed as part of the mandrel to form one cohesive unit.

The mixing system disclosed herein allows for continuous mixing of additives with an oil of lubricating viscosity and/or fuel to product a lubricant or fuel additive mixture. The process disclosed herein can produce over 75 kg/hour, or 100 kg/hour, or over 150 kg/hour, or up to 175 kg/hour, or up to 200 kg/hour or final mixed product. In some embodiments, the process disclosed herein provides continuous mixing through an acoustically resonating coil at throughput rates equivalent to plant scale.

In some embodiments, the acoustic mixer can be used to mix at least 2, or at least 3, or at least 4, or at least 5, or at least 6, or at least 7, or at least 8, or at least 9, or at least 10 additives.

The various embodiments of the acoustic mixer disclosed herein may be used to mix one or more additives with an oil of lubricating viscosity or a fuel to generate a lubricant or fuel additive mixture. In some embodiments, the additives may be mixed in the acoustic mixer to form a concentrate that is later, optionally, mixed in an acoustic mixer with an oil of lubricating viscosity or a fuel.

In some embodiments, the acoustic mixer may be used to pre-mix additives such as a dispersant and a detergent (such as a PIB or polyolefin-based dispersant with a alkaline earth metal sulfonate or phenate detergent) to form compatible mixtures that may be used in an additive concentrate or incorporated directly into a lubricant composition. In other embodiments, the acoustic mixer may be used to incorporate an antifoam, particularly a siloxane-based antifoam, into an additive concentrate with multiple other additives or directly into a lubricant composition.

In some embodiments, the lubricant prepared according to the instant process is formulated to lubricate a mechanical device. The mechanical device can be associated with an automotive vehicle such as, for example, a driveline device. Driveline devices include automatic transmissions, manual transmission, dual clutch transmissions, or an axle or differential.

A driveline device lubricating composition in different embodiments may have a composition as disclosed in the following table:

| | Embodiments (wt %) | | | |
|---|---|---|---|---|
| Additive | A | B | C | D |
| Dispersant | 1 to 4 | 0.1 to 10, | 0 to 5 | 1 to 6 |
| | | 2 to 7 | | |
| Extreme Pressure Agent | 3 to 6 | 0 to 6 | 0 to 3 | 0 to 6 |
| Overbased Detergent | 0 to 1 | 0.01 to 3, | 0.5 to 6 | 0.01 to 2 |
| | | 0.025 to 2 | | |
| Antioxidant | 0 to 5 | 0.01 to 10 or 2 | 0 to 3 | 0 to 2 |
| Friction Modifier | 0 to 5 | 0.01 to 5 | 0.1 to 1.5 | 0 to 5 |
| Viscosity Modifier | 0.1 to 70 | 0.1 to 15 | 1 to 60 | 0.1 to 70 |
| Any Other Performance Additive | 0 to 10 | 0 to 8 or 10 | 0 to 6 | 0 to 10 |

| | |
|---|---|
| Oil of Lubricating Viscosity | Balance to 100% |

Footnote:
The viscosity modifier in the table above may also be considered as an alternative to an oil of lubricating viscosity.
Column A may be representative of an automotive or axle gear lubricant.
Column B may be representative of an automatic transmission lubricant.
Column C may be representative of an off-highway lubricant.
Column D may be representative of a manual transmission lubricant.

The mechanical device can be an internal combustion engine, such as, for example, a spark ignited internal combustion engine or a compression ignition internal combustion engine. An engine lubricant composition in different embodiments may have a composition as disclosed in the following table:

| | Embodiments (wt %) | | |
|---|---|---|---|
| Additive | A | B | C |
| Corrosion Inhibitor | 0.05 to 2 | 0.1 to 1 | 0.2 to 0.5 |
| Other Overbased Detergent | 0 to 9 | 0.5 to 8 | 1 to 5 |
| Dispersant Viscosity Modifier | 0 to 5 | 0 to 4 | 0.05 to 2 |
| Dispersant | 0 to 12 | 0 to 8 | 0.5 to 6 |
| Antioxidant | 0.1 to 13 | 0.1 to 10 | 0.5 to 5 |
| Antiwear Agent | 0.1 to 15 | 0.1 to 10 | 0.3 to 5 |
| Friction Modifier | 0.01 to 6 | 0.05 to 4 | 0.1 to 2 |
| Viscosity Modifier | 0 to 10 | 0.5 to 8 | 1 to 6 |
| Any Other Performance Additive | 0 to 10 | 0 to 8 | 0 to 6 |

| | |
|---|---|
| Oil of Lubricating Viscosity | Balance to 100 % |

The mechanical device may also be in a hydraulic system. A hydraulic lubricant may also comprise a formulation defined in the following table:

Hydraulic Lubricant compositions

| | Embodiments (wt %) | | |
|---|---|---|---|
| Additive | A | B | C |
| Antioxidant | 0 to 4.0 | 0.02 to 3.0 | 0.03 to 1.5 |
| Dispersant | 0 to 2.0 | 0.005 to 1.5 | 0.01 to 1.0 |
| Other Detergent-beside | 0 to 5.0 | 0.001 to 1.5 | 0.005 to 1.0 |
| alkylphenol detergent as | | | |
| described herein | | | |
| Anti-wear Agent | 0 to 5.0 | 0.001 to 2 | 0.1 to 1.0 |
| Friction Modifier | 0 to 3.0 | 0.02 to 2 | 0.05 to 1.0 |
| Viscosity Modifier | 0 to 10.0 | 0.5 to 8.0 | 1.0 to 6.0 |
| Any Other Performance Additive | 0 to 1.3 | 0.00075 to 0.5 | 0.001 to 0.4 |
| (antifoam/demulsifier/pour point | | | |
| depressant) | | | |
| Metal Deactivator | 0 to 0.1 | 0.01 to 0.04 | 0.015 to 0.03 |
| Rust Inhibitor | 0 to 0.2 | 0.03 to 0.15 | 0.04 to 0.12 |
| Extreme Pressure Agent | 0 to 3.0 | 0.005 to 2 | 0.01 to 1.0 |
| Oil of Lubricating Viscosity | Balance to 100% | Balance to 100% | Balance to 100% |

The mechanical device may also be in an Industrial Gear. An Industrial Gear lubricant may also comprise a formulation defined in the following table:

Industrial Gear Lubricant compositions

| | Embodiments | | |
|---|---|---|---|
| Additive | A | B | C |
| Dispersant | 0 to 2.0 | 0.05 to 1.5 | 0.01 to 1 |
| Antifoam Agent | 0.001 to 0.012 | 0.001 to 0.004 | 0.001 to 0.003 |
| Demulsifier | 0.002 to 2 | 0.0025 to 0.5 | 0.005 to 0.04 |
| Metal Deactivators | 0.001 to 0.5 | 0.01 to 0.04 | 0.015 to 0.03 |
| Rust Inhibitor | 0.001 to 1.0 | 0.005 to 0.5 | 0.01 to 0.25 |
| Extreme Pressure Agent | 0.05 to 5.0 | 0.01 to 4.0 | 0.1 to 3 |
| Antiwear Agent | 0 to 3.0 | 0.005 to 2 | 0.01 to 1.0 |
| Oil of Lubricating Viscosity | Balance to 100% | Balance to 100% | Balance to 100% |

The mechanical device may also be lubricated by a grease. An Grease additive Package composition may comprise a grease formulation defined in the following table:

Grease Additive package Compositions*

| | Embodiments | |
|---|---|---|
| | | High Temp- |
| Additive | Multi-functional | Long life |
| Dispersant | 0.5 to 5.0 | — |
| Antioxidant | 10 to 20 | 25.0 to 60.0 |
| Metal Deactivators | 1.0 to 8 | — |
| Rust Inhibitor | 1.0 to 5.0 | 30.0 to 40.0 |
| Extreme Pressure Agent | 45.0 to 65.0 | 0.1 to 10.0 |
| Antiwear Agent | — | 5.0 to 15 |
| Oil of Lubricating Viscosity | Balance to 100% | Balance to 100% |

### Grease

In one embodiment, the lubricant is a grease. The grease may have a composition comprising an oil of lubricating viscosity, a grease thickener, and an additive package. The additive package comprises the seal swell agent of the invention (the compound of formula (I)) and, optionally, other performance additives.

The grease thickening agent, or thickener, may include a metal salt of one or more carboxylic acids that is known in the art of grease formulation. Often the metal is an alkali metal, alkaline earth metal, aluminum, or mixtures thereof. Examples of suitable metals include lithium, potassium, sodium, calcium, magnesium, barium, titanium, aluminum, and mixtures thereof. The metal may include lithium, calcium, aluminum, or mixtures thereof (typically lithium).

The carboxylic acid used in the thickener is often a fatty acid and may include a mono-hydroxycarboxylic acid, a di-hydroxycarboxylic acid, a poly-hydroxycarboxylic acid or mixtures thereof. The carboxylic acid may have 4 to 30, 8 to 27, 19 to 24 or 10 to 20 carbon atoms and may include derivatives thereof such as esters, half esters, salts, anhydrides, or mixtures thereof. A particularly useful hydroxy-substituted fatty acid is hydroxystearic acid, wherein one or more hydroxy groups are often located at positions 10-, 11-, 12-, 13−or 14- on the alkyl group. Suitable examples may include 10-hydroxy stearic acid, 11-hy- droxystearic acid, 12-hydroxy stearic acid, 13 -hydroxystearic acid, 14-hydroxystearic acid and mixtures thereof. In one embodiment the hydroxy-substituted fatty acid is 12-hy- droxystearic acid. Examples of other suitable fatty acids include capric acid, palmitic acid, stearic acid, oleic acid, behenic acid, and mixtures thereof.

In one embodiment, the carboxylic acid thickener is supplemented with a dicarboxylic acid, a polycarboxylic acid, or mixtures thereof. Suitable examples include hexanedioic acid (adipic), isooctanedioic acid, octanedioic acid, nonanedioic acid (azelaic acid), decanedioic acid (sebacic acid), undecanedioic acid, dodecanedioic acid, tridecanedioic acid, tetradecanedioic acid, pentadecanoic acid and mixtures thereof. The dicarboxylic acid and polycarboxylic acid tend to be more expensive than monocarboxylic acid and as a consequence, most industrial processes using mixtures typically use a molar ratio of dicarboxylic and/or polycarboxylic acid to monocarboxylic acid in the range 1:10 to 1:2, including 1:5, 1:4, 1:3, or 1:2 as possible values or upper or lower limits. The actual ratio of acids used depends on the desired properties of the grease for the actual application. In one embodiment the dicarboxylic acid thickener is nonanedioic acid (azelaic acid) and in another decanedioic acid (sebacic acid), or mixtures thereof.

The grease thickener may include simple metal soap grease thickeners, mixed alkali soaps, complex soaps, non-soap grease thickeners, metal salts of such acid-functional-ized oils, polyurea and diurea grease thickeners, calcium sulfonate grease thickeners or mixtures thereof.

The grease thickener may also include or be used with other known polymer thickening agents such polytetrafluoroethylene (commonly known as PTFE), styrene-buta- diene rubber, styrene-isoprene polymers, olefin polymers such as polyethylene or polypropylene or olefin co-polymers such as ethylene-propylene or mixtures thereof.

In one embodiment the thickener may also include or be used with other known thickening agents such as inorganic powders including clay, organo-clays, bentonite, mont- morillonite, fumed and acid modified silicas, calcium carbonate as calcite, carbon black, pigments, copper phthalocyanine or mixtures thereof.

The grease may also be a sulfonate grease. Sulfonate greases are disclosed in more detail in U.S. Pat. No. 5,308,514. The calcium sulfonate grease may be prepared from overbasing a neutral calcium sulfonate such that the calcium hydroxide is carbonated to form amorphous calcium carbonate and subsequently converted into either calcite, or vaterite or mixtures thereof, but typically calcite.

The grease thickener may be a urea derivative such as a polyurea or a diurea.

Polyurea grease may include tri-urea, tetra-urea or higher homologues, or mixtures thereof. The urea derivatives may include urea-urethane compounds and the urethane compounds, diurea compounds, triurea compounds, tetraurea compounds, polyurea compounds, urea- urethane compounds, diurethane compounds and mixtures thereof. The urea derivative may for instance be a diurea compound such as, urea-urethane compounds, diurethane compounds or mixtures thereof. A more detailed description of urea compounds of this type is disclosed in U.S. Pat. No. 5,512,188 column 2, line 24 to column 23, line 36.

In one embodiment, the grease thickener may be polyurea or diurea. The grease thickener may be a lithium soap or lithium complex thickener. The grease thickener may be an aluminum soap, calcium soap, aluminum complex or calcium complex thickener.

The amount of grease thickener present in the grease composition includes those in the range from 1 wt % to 50 wt %, 1 wt % to 45 wt %, or 2 wt % to 40 wt %, or 3 wt % to 20 or 25 wt % of the grease composition.

The lubricating grease composition comprises an oil of lubricating viscosity as is described above. A lubricating grease composition may be prepared by nixing one or more additives described above, or, alternatively, a concentrate of additives, to an oil of lubricating viscosity, a grease thickener, and the like to form the final grease product.

In preparing the lubricant and/or fuel additive mixture, any of the foregoing additives including those disclosed in the Tables can be mixed in the acoustic mixer prior to introduction of the oil of lubricating viscosity and or fuel. In an alternative, all of the formulation components can be metered and mixed simultaneously to prepare the final lubricant and/or fuel additive mixture.

Components mixed according to the instant process have unexpectedly shown improved product integrity. Product integrity can include one or more of a clear product, no precipitation, storage stable, improve shelf life, and the like. The instant process allows for better mixing of additives, and, for example, better antifoam stability to blends. The process enables troublesome products to be mixed with better stability, product integrity, improved clarity, and the like.

### EXAMPLES

At present, it has been demonstrated that three components can be pumped via a manifold into a single stream that flows from the bottom of coil to the top and exits a fully mixed product from an acoustic mixer disclosed herein. The use of independent peristaltic pumps allows for the control of ratios of each of the three components entering the manifold. Total residence time in the resonating coil is less than 20 seconds. A pulse of air is introduced to the stream prior to entering the resonating coil as acoustic requires a gas/liquid interface for mixing to occur. This is controlled via a timed solenoid valve opening and closing to allow compressed air to enter the stream at a specific rate.

To evaluate whether a consistent stream of finished product can be produced in this process, three components of varying elemental composition and viscosity were blended in a specific ratio.

Component 1 had a calcium content of 20500 ppm and was added at a ratio of 50%.

Component 2 had a titanium content of 10000 ppm and was added at a ratio of 40%. Component 3 had a zinc content of 110500 ppm and phosphorus content of 100000 ppm and was added at a ratio of 10%.

Pump flow rates were calculated to added each of the components at the specific ratios and the system was allowed to purge for 15 minutes. The following table features the ICP results from samples taken at specific points of continuous operation.

| | | | S000- | S000- | S000- | S000- |
|---|---|---|---|---|---|---|
| | | S000- | 0004-18-241, | 0004-18-242, | 0004-18-243, | 0004-18-244, |
| | | 0004-18-247, | Sample 1 | Sample 2 | Sample 3 | Sample 4 |
| D4951 | Theoretical | Control | 10:45 am | 11:00 am | 11:15 am | 11:45 am |
| CALCIUM | 10250 | 9879 | 8983 | 9580 | 9522 | 9486 |
| ppm | | | | | | |
| TITANIUM | 4000 | 3858 | 3824 | 4082 | 4130 | 4134 |
| ppm | | | | | | |
| PHOSPHORUS | 10000 | 10038 | 15899 | 9080 | 8987 | 9449 |
| ppm | | | | | | |
| ZINC ppm | 11050 | 11106 | 17806 | 10078 | 9970 | 10614 |

Sample 1 ICP results are inconsistent with the control sample and subsequent samples suggesting the system was not fully purged and ratios were not balanced correctly. However, samples 2, 3 and 4 are all very consistent with each other proving a constant stream of product is being made. Results for these samples are slightly out of line with the control sample but this could be corrected by altering the pump flow rates accordingly, the important aspect is that consistent product is being made.

### Gear Oil Compositions

Gear oil composition were mixed and are shown in Table A below. Gear Oil A (Oil A) was blended using standard heat and paddle stirring and Gear Oil B (Oil B) was mixed using resonant acoustic mixing. The blending efficiency for each oil was measured using the ASTM D892 Foam Tests for Lubricating Oils. ASTM D892 foam test was used to evaluate the foaming tendency and stability of the oils. In the ASTM Test Method D892, air is blown at a constant rate for 5 min in a 200 mL oil sample at 24° C., then allowed to settle for 10 min. The volume of foam is measured each time.

TABLE A
Gear Oil Compositions:

| | % wt. Oil | |
|---|---|---|
| Additive | Free Basis | Chemistry |
| Detergent | 0.735 | High TBN Magnesium Sulfonate |
| Antioxidant | 0.144 | Zinc dialkydithiophosphate |
| Antioxidant | 0.75 | Alkyl phosphonate |
| Antiwear | 1 | Alkenyl Sulfide ester |
| Seal Swell Agent | 0.3 | Heterocyclic ether |
| Friction Modifier | 0.25 | Alkyl Amide |
| Antifoam 1 | 0.00525 | Polyalkyl Siloxane |
| Antifoam 2 | 0.014 | Polyalkyl Siloxane |
| Viscosity Modifier | 10.8 | Copolymer Ester |
| Pour Point | 0.125 | Methacrylate Copolymer |
| Depressant | | |
| Oil | To 100% | 100N Group I Base Oil |

The foaming tendency of both Oil A and Oil B is shown in Table B, a fail indicates that the oil had greater than 50% foam.

TABLE B
Foaming Tendency of Gear Oil Compositions

| Time | Oil A | Oil B |
|---|---|---|
| Initial | FAIL | PASS |
| 1 Month | FAIL | PASS |
| 2 Month | FAIL | PASS |
| 3 Month | FAIL | PASS |
| 4 Month | FAIL | PASS |
| 5 Month | FAIL | PASS |
| 6 Month | FAIL | PASS |

Oil B mixed using resonant acoustic mixing illustrated better incorporation of the antifoams in the gear oil lubricant composition.

### Heavy-Duty Diesel Oil Compositions

Heavy Duty Diesel Oil compositions were prepared according to Table C below. HD Oil C was (Oil C) was blended using standard heat and paddle stirring and HD (Oil D) was mixed using resonant acoustic mixing.

Table C: Heavy Duty Diesel Engine Oil Composition:

TABLE C
Heavy Duty Diesel Engine Oil composition

| Additive | % wt. Oil Free Basis | Chemistry |
|---|---|---|
| Corrosion Inhibitor | 0.1 | Heterocycle-Thiadiazole |
| Detergent 1 | 1.0498 | Calcium Sulfonate |
| Detergent 2 | 4.145 | Calcium Sulfonate |
| Detergent 3 | 2.1012 | Magnesium Sulfonate |
| Detergent 4 | 1.76 | Magnesium Phenate |
| Dispersant 1 | 0.61415 | Polyisobutenyl Succinimide |
| Dispersant 2 | 7.05 | Polyisobutenyl Succinimide |
| Dispersant 3 | 4.76 | Polyisobutenyl Succinimide borated |
| Dispersant 4 | 3.45 | Polyisobutenyl Succinimide |
| Antioxidant 1 | 0.8645 | Zinc Dialkyldithiophosphate |
| Antioxidant 2 | 2.852 | Zinc Dialkyldithiophosphate |
| Antioxidant 3 | 10 | Alkaryl Amine |
| Antioxidant 4 | 1.19 | Olefin Sulfide |
| Antioxidant 5 | 5.24 | Alkylated Phenol |
| Pour Point Depressant | 0.38 | Copolymer Ester |
| Antifoam 1 | 0.048 | Polyalkyl Siloxane |
| Antifoam 2 | 0.0048 | Polyalkyl Siloxane |
| Viscosity Modifier | 0.56 | Olefin-aromatic copolymer |
| Viscosity Modifier | 1.2376 | Polyolefin Amide Alkeneamine |
| Viscosity Modifier | 1.5708 | Polyolefin Amide Alkeneamine |
| Base Oil | To 100% | Base Oil |

The foaming tendency of both Oil A and Oil B is shown in Table D:

TABLE D
Foaming Tendency of the Heavy Duty Diesel Oil Compositions:

| Time | Oil C | Oil D |
|---|---|---|
| Initial | FAIL | PASS |
| 1 Month | FAIL | PASS |
| 2 Month | FAIL | PASS |
| 3 Month | FAIL | PASS |
| 4 Month | FAIL | PASS |
| 5 Month | FAIL | PASS |
| 6 Month | FAIL | PASS |

Oil D mixed using resonant acoustic mixing illustrated better incorporation of the antifoams in the Heavy Duty Diesel lubricant composition.

Passenger Car Motor Oil concentrates were prepared by the formulations shown in Table E. The concentrates prepared by first premixing the Dispersant 1 and Detergent 1 by heat (70° C.) and paddle for two minutes (Oil E) or by using resonant acoustic mixing for 2 minutes at 100° C. (Oil F).

TABLE E
Passenger Car Motor Oil Composition:

| Additive | % wt. Oil Free Basis | Chemistry |
|---|---|---|
| Dispersant 1 | 16.60 | Polyolefin Amide Alkeneamine |
| Detergent 1 | 5.21 | Magnesium Sulfonate |
| Dispersant 2 | 9.30 | Polyolefin Amide Alkeneamine |
| Dispersant 3 | 0.90 | Polyolefin Amide Alkeneamine |
| Dispersant 4 | 1.53 | Polyolefin Amide Alkeneamine |
| Friction Modifier 1 | 2.10 | Alkyl Imide |
| Friction Modifier 2 | 1.40 | Alkhl Ester |
| Friction Modifier 3 | 2.11 | Alkyl Ester |
| Antioxidant 1 | 9.65 | Alkaryl Amine |
| Antioxidant 2 | 2.19 | Olefin Sulfide |
| Antioxidant 3 | 1.60 | Zinc Alkyldithiophosphate |
| Antioxidant 4 | 5.33 | Zinc Alkyldithiophosphate |
| Antioxidant 5 | 0.31 | Molybdenum Compound |
| Antioxidant 6 | 2.19 | Alkyl Borate |
| Pour Point Depressant 1 | 0.53 | Copolymer Ester |
| Pour Point Depressant 2 | 0.04 | Methacrylate Copolymer |
| Detergent 2 | 5.09 | Calcium Sulfonate |
| Antifoam | 0.01 | Polyalkyl Siloxane |
| Antifoam | 0.01 | Polyalkyl Siloxane |
| Diluent Oil | To 100% | 100N Group I Oil |

The oils were then stored at 70° C. for 8 weeks. At the end of each week, the oils were rated on appearance, percent of lower phase separation percent of solid sedimentation with the following results shown in Table F.

TABLE F
Storage Stability of Passenger Car Motor Oil concentrate:

| | Oil E | | | Oil F | | |
|---|---|---|---|---|---|---|
| Time | | Phase | | | Phase | |
| (week) | Appearance | Sep % | Sed % | Appearance | Sep % | Sed % |
| 1 | VSLZ | 0 | 0 | C | 0 | 0 |
| 2 | VSLZ | 0 | 0 | C | 0 | 0 |
| 3 | VSLZ | 0.05 | 0 | C | 0 | 0 |
| 4 | VSLZ | 0.05 | 0 | C | 0 | 0 |
| 5 | VSLZ | 0.1 | 0 | C | 0 | 0 |
| 6 | VSLZ | 0.1 | 0 | C | 0 | 0 |
| 7 | VSLZ | 0.1 | 0 | C | 0 | 0 |
| 8 | VSLZ | 0.1 | 0 | C | 0 | 0 |

VSLZ = slightly hazy
C = Clear

Oil F illustrates that premixing the dispersant and detergent with resonant acoustic mixing produced better storage stability in the additive concentrate.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

As used herein, the term “about” means that a value of a given quantity is within ±20% of the stated value. In other embodiments, the value is within ±15% of the stated value. In other embodiments, the value is within ±10% of the stated value. In other embodiments, the value is within ±5% of the stated value. In other embodiments, the value is within ±2.5% of the stated value. In other embodiments, the value is within ±1% of the stated value.

Additionally, as used herein, the term “substantially” means that a value of a given quantity is within ±10% of the stated value. In other embodiments, the value is within ±5% of the stated value. In other embodiments, the value is within ±2.5% of the stated value. In other embodiments, the value is within ±1% of the stated value.

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of” where “consisting of” excludes any element or step not specified and “consisting essentially of”permits the inclusion of additional un-recited elements or steps that do not materially affect the essential or basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject disclosure.

1. A process comprising:
mixing in an acoustic mixer one or more additives selected from a dispersant, an antioxidant, a performance polymer, a detergent, an antiwear agent, a friction modifier, a demulsifier, an antifoam additive, a rust inhibitor, a metal deactivator, a seal swell agent and combinations thereof to form a final product.

2. The process of claim 1, wherein the one or more additives are premixed prior to mixing with an oil of lubricating viscosity.

3. The process of claim 1, further comprising injecting air into the one or more additives, the oil of lubricating viscosity, or combination thereof prior to the mixing.

4. The process of claim 1, wherein the acoustic mixer includes:
a process vessel in communication with an acoustic agitator, the process vessel including at least one inlet to receive the one or more additives, the oil of lubricating viscosity, or combinations thereof.

5. The process of claim 4, wherein the process vessel is a continuous conduit serpentining along a central line of a mandrel where the conduit has an inlet at a bottom of the mandrel and an outlet at the top of the mandrel, the process vessel being configured to provide continuous acoustic mixing in the conduit along the mandrel.

6. The process of claim 5, wherein the conduit inlet is in operable communication with a manifold, the manifold having at least one inlet configured to receive and transmit the one or more additives, the oil of lubricating viscosity, or combinations thereof to the process vessel.

7. The process of claim 6, wherein the manifold further comprises an air inlet configured to receive and mix air with one or more additives, the oil of lubricating viscosity, or combinations prior to the process vessel.

8. The process of claim 7, wherein the manifold further comprises a pre-mixer configured to mix the one or more additives, the oil of lubricating viscosity, the air, or combinations thereof prior to the mixing with the acoustic mixer.

9. The process of claim 8, wherein the pre-mixer is a venturi mixer.

10. The process of claim 1, wherein the final product is used to form one or more of an engine oil lubricant, a drivetrain lubricant, a hydraulic fluid, and a metal working lubricant.

11. The process of claim 1, wherein the final product is used to form a one or more of a heavy-duty diesel passenger car motor oil, a marine diesel composition, a two-stroke engine composition, a gear oil, an automatic transmission lubricant, a manual transmission lubricant, an industrial lubricant composition, a hydraulic oil, an industrial gear oil, and a grease.

12. The process of claim 1, wherein the one or more additives includes at least 2, or at least 3, or at least 4, or at least 5, or at least 6, or at least 7, or at least 8, or at least 9, or at least 10 additives.

13. The process of claim 12, wherein mixing includes mixing at least three of the one or more additives.

14. The process of claim 1, wherein the final product is an additive concentrate.

15. The process of claim 14, wherein the concentrate is blended with an oil of lubricating viscosity.

16. The process of claim 1, wherein mixing includes mixing the one or more additives with an oil of lubricating viscosity.

17. The process of claim 1, wherein the mixing includes mixing a dispersant and a detergent.

18. The process of claim 17, wherein the dispersant includes a dispersant selected from a PIB based dispersant and a polyolefin-based dispersant and the detergent is an alkaline earth metal detergent selected from a sulfonate and phenate.

19. The process of claim 1, wherein the mixing includes mixing an antifoam with at least one additional additive.

20. The process of claim 19, wherein the antifoam is a siloxane-based antifoam.

21.-22. (canceled)

23. A process for preparing a fuel-additive composition comprising:
mixing in an acoustic mixer one or more additives selected from a dispersant, an antioxidant, a performance polymer, a detergent, an antiwear agent, a friction modifier, a demulsifier, an antifoam additive, a metal deactivator and combinations thereof to form the fuel-additive composition.

24. The process of claim 23, further comprising mixing the fuel-additive composition with a fuel.

25. (canceled)
